(19) United States
(12) Patent Application Publication
(10) Pub. No.: US 2024/0135311 A1
(43) Pub. Date: Apr. 25, 2024

(54) Micro-tracking device (M-TDnm)

(71) Applicant: Mark Eklund, Ocean View, DE (US)

(72) Inventor: Mark Eklund, Ocean View, DE (US)

(21) Appl. No.: 17/803,694

(22) Filed: Oct. 14, 2022

(51) Int. Cl. G06Q 10/087

(52) U.S. Cl. CPC G06Q 10/087

(57) ABSTRACT

Micro-Tracking Device (M-TD^{nm}) is a micro-scale technology to assist in asset automated supply chain & logistics asset management employing OFiD (Optical Frequency Identification) and Raman scattering (a cumulative process having net effects of scattering photons and changing their frequency). This manipulation of frequency provides a ‘carrier wave’ for M-TD^{nm} interrogation via Raman spectroscopy. The component parts of the M-TD^{nm} (including silicone substrate, conduction band, and membrane) provide for an ‘E-beam resist’ function. The E-beam resist layer is coded with an arrangement of electrons, serving as a unique identifier. M-TD^{nm} is subject to interrogation via Raman spectroscopy, the Raman spectrum reading is interpreted via an optical frequency identification (OFiD) method. Likewise alternate versions and variations can include energy harvesting mechanisms via polarity and conduction choice of the arrangement of electrons, and nanowire antenna.

### CROSS-REFERENCE TO RELATED APPLICATIONS

To the extent possible, this application would claim the benefit of priority of U.S. Provisional No. 62/995,614, filed on Feb. 5, 2020, titled “Micro-Track Device (M-TD^{nm})” with an M-TD filing confirmation number of 2338, and an Application No. of Ser. No. 17/300,013.

### STATEMENT REGARDING FEDERALLY SPONSORED RESEARCH & DEVELOPMENT

This invention was made independent of any government support. The United States government has no rights in the invention.

### THE NAMES OF THE PARTIES TO A JOINT RESEARCH AGREEMENT

Not Applicable. The sole inventor of this disclosure is Mark C. Eklund.

### STATEMENT REGARDING PRIOR DISCLOSURES BY THE INVENTOR

Prior disclosure(s) include the USPTO filing of Micro-Track Device (M-TD^{nm}) assigned the U.S. Provisional number of No. 62/995,614, filed on Feb. 5, 2020.

### BACKGROUND OF THE INVENTION

### (1) Field of the Invention

Considering the grounded literature in RFiD technology, the limitations of physics and extant patents, while it's possible to produce a miniature (micro- to nano-scale) RFiD tag with a greater amount of memory (up to 2 kilobytes), such a tag would have a very truncated read-range. This is due to the fact that while a miniature (micro- to nano-scale) antenna can capture sufficient energy from a reader, its inherent limitations of scale are such that it cannot reliably reflect a strong enough signal to a reader/receiver upon interrogation. Hence, to accomplish alternate methods of RFiD-like sensor functionality for the purposes of reduced size we propose OFiD (i.e., Optical Frequency Identification), which likewise requires alternate methods of interrogation, thereby making the Micro-Track Device (M-TD^{nm}) technology distinct from RFiD. This invention relates to a method and system for the asset identification and location.

### (2) Description of Related Art (Including Information Disclosed Under 37 CFR 1.97 and 1.98)

USPTO patent pending 62/995,614 contains a background section which notes alternate methods of sensor functionality, namely OFiD (i.e., Optical Frequency Identification), which likewise requires alternate methods of interrogation, thereby making the Micro-Track Device (M-TD^{nm}) technology distinct from RFiD and SERS-active nanoparticle will absorption of US-20100177306-A1. USPTO filing 62/995,614 (M-TD^{nm}) is a technology employing OFiD and Raman scattering (a cumulative process having net effects of scattering photons and changing their frequency). The spectrographic interrogation system that overcomes the optical diffraction limit in Tip-Enhanced Raman Scattering (TERS) is an optical interrogation method (OFiD).

Conversely, US-20100177306-A1 functions thusly:
A method of producing a surface enhanced Raman scattering spectrum which is useful for certain types of assays, in particular proximity assays. The method includes providing two SERS-active nanoparticles. The first SERS-active nanoparticle will absorb a photon at a first wavelength and emit a Raman-shifted photon at a second wavelength. The second SERS-active nanoparticle will absorb a photon at the second wavelength and emit a Raman-shifted photon at a third wavelength. Accordingly, when the first and second SERS-active nanoparticles are proximate to one another and the first SERS-active nanoparticle is illuminated at the first wavelength a Raman-shifted photon at the second wavelength may be emitted.

The above referenced passages involve photons absorbed by the standing SERS-active nanoparticle causing detectable emission of a second Raman-shifted photon at the third wavelength. Various assays designed based upon prior proximity assays using two SERS-active nanoparticles had advantageous background signal characteristics.

USPTO filing 62/995,614 involves a unique method of sensor functionality, namely OFiD (i.e., Optical Frequency Identification), which likewise requires alternate methods of interrogation, thereby making the M-TD^{nm} distinct from SERS-active nanoparticle will absorption of US-20100177306-A1 wherein:
surface enhanced Raman spectroscopy, if left uncoupled and complemented by the Rayleigh criterion requirement, is less effective than proposed OFiD such that the optical diffraction limit, D, is defined as

$$D = k \frac{λ}{NA}$$

Here, λ and NA refer to the optical wavelength and the numerical aperture of the lens, respectively. And k is the factor which depends on the incident beam profile of the lens. For uniform interrogation of the M-TD via an OFiD system, k=˜0.61 (this is the Rayleigh criterion requirement, the generally accepted criteria for the minimum resolvable image or signal fidelity, i.e., 0.61), I realized that k can be varied to as little as 0.36. With k=0.36 and NA=0.9, near-ultraviolet (UV) light (λ=400 nm) can be narrowed to D≈140 nm (tolerances employed in contemporary photolithography; i.e., the microfabrication semiconductors, or semiconductor lithography), while remaining inviolate of the applicable formula. With the same illumination, D=100 nm can be achieved with commercially available technology, such that NA=1.4. This variation in the diffraction limit comports with the formula and is a substantial variation from the extant SRS, TERS & STM-TERS patents.

USPTO patent pending 62/995,614 contains a background section which notes alternate methods of sensor functionality, namely OFiD (i.e., Optical Frequency Identification), which likewise requires alternate methods of interrogation, thereby making the Micro-Track Device (M-TD^{nm}) technology distinct from RFiD and a system and method for highly-multiplexed, label-free detection of analytes using optical tags.

USPTO filing 62/995,614 (M-TD^{nm}) is a technology employing OFiD and Raman scattering (a cumulative process having net effects of scattering photons and changing their frequency). The spectrographic interrogation system that overcomes the optical diffraction limit in Tip-Enhanced Raman Scattering (TERS) is an optical interrogation method (OFiD).

Conversely, US-20170226571-A1 functions thusly:
Compositions, systems, and methods for performing a biological or chemical analysis of a sample using encoded functionalized optical tags. These optical tags can generate a unique spectral signature correlated with the identity of a probe bound to the optical tag, and a state of the interaction of the probe with an analyte. Also provided herein are methods of generating encoded functionalized optical tags.

The above referenced passages involve the optical tag comprising a silica linker. The linker is an organofunctional alkoxysilane molecule. In some embodiments, the probe is bound to the surface of the optical tag. In some embodiments, the probe is bound within one of said plurality of pores of the optical tag.

USPTO filing 62/995,614 favors OFiD and Raman scattering (a cumulative process having net effects of scattering photons and changing their frequency). The spectrographic interrogation system that overcomes the optical diffraction limit in Tip-Enhanced Raman Scattering (TERS) is an optical interrogation method (OFiD) wherein:
FDTD method (Finite-Difference Time-Domain) is applied, which is a numerical analysis technique used for modeling computational electrodynamics, which required the further application of the Lorentz-Drude model to solve the problem arising from the conventional optical physics models in which only the surface effect is accounted for. The Drude dispersive model for surface plasmons (coherent but delocalized electron oscillations that exist at the interface between any two materials, wherein the real part of the dielectric function changes pos+/neg− orientation, across the interface) in the frequency domain can be expressed as

$${ε}_{r}^{f} ( ω ) = 1 + \frac{{Ω}_{p}^{2}}{j Ω {Γ}_{0} - {ω}^{2}} .$$

The Lorentz model is expressed as

$${ε}_{r}^{b} ( ω ) = {\sum }_{m = 1}^{M} \frac{{G}_{m} {ω}_{p}^{2}}{{ω}_{m}^{2} - {ω}^{2} + j ω {Γ}_{m}}$$

such that the complex dielectric function, εᵣ(ω), will be based upon the Lorentz-Drude model in the frequency domain (to be determined in Phase 2). The purpose of this avenue of pursuit to conceptually create OFiD as an integrated aspect of M-TD is to enhance the surface sensitivity of OFiD spectroscopic measurements via fluorescence, or Raman scattering, as enhanced by surface plasmons.

USPTO patent pending 62/995,614 contains a background section which notes alternate methods of sensor functionality, namely OFiD (i.e., Optical Frequency Identification), which likewise requires alternate methods of interrogation, thereby making the Micro-Track Device (M-TD^{nm}) technology distinct from RFiD and one-dimensional arrays of block copolymer cylinders and applications.

USPTO filing 62/995,614 (M-TD^{nm}) is a technology employing OFiD and Raman scattering (a cumulative process having net effects of scattering photons and changing their frequency). The spectrographic interrogation system that overcomes the optical diffraction limit in Tip-Enhanced Raman Scattering (TERS) is an optical interrogation method (OFiD).

Conversely, US-20060078681-A1 functions thusly:
A method of forming a nanostructured polymer material on a substrate, forming a self-assembling block copolymer material within a single trench or a plurality of trenches having ends not aligned, said trench(es) in a material layer on the substrate, the trench(es) having a neutral wetting floor, and opposing sidewalls and ends that are preferentially wetting to a minority block of the block copolymer; and annealing the block copolymer material such that said block copolymer material self-assembles into cylindrical domains of the first block of the block copolymer within a matrix of a second block of the block copolymer.

The above referenced passages involve self-assembled block copolymer material having a thickness, and the cylindrical polymer domains oriented perpendicular to the trench floor and extending through said thickness of the self-assembled block copolymer material in a one-dimensional (1-D) array of a single row for the length of the trench(es) at multiple scales.

USPTO filing 62/995,614 may involve polymerized siloxanes or polysiloxanes wherein:
silicones consist of an inorganic silicon-oxygen backbone chain ( . . . —Si—O—Si—O—Si—O— . . . ) with organic side groups attached to the silicon atoms. These silicon atoms are tetravalent. So, silicones are polymers constructed from inorganic-organic monomers such that Micro-Track Device (M-TD^{nm}) technology silicones are [R₂SiO]ₙ, where R is an organic group such as an alkyl (methyl, ethyl) or phenyl group, at various scales.

USPTO patent pending 62/995,614 contains a background section which notes alternate methods of sensor functionality, namely OFiD (i.e., Optical Frequency Identification), which likewise requires alternate methods of interrogation, thereby making the Micro-Track Device (M-TD^{nm}) technology distinct from RFiD and the master plate and method of manufacturing, production and functionality of US-20100213069-A1.

USPTO filing 62/995,614 (M-TD^{nm}) is a technology employing OFiD and Raman scattering (a cumulative process having net effects of scattering photons and changing their frequency). The spectrographic interrogation system that overcomes the optical diffraction limit in Tip-Enhanced Raman Scattering (TERS) is an optical interrogation method (OFiD).

Conversely, US-20100213069-A1 functions thusly:
A master plate for producing a stamper includes a substrate, and patterns of protrusions and recesses formed on the substrate and corresponding to patterns of recording tracks or recording bits in data areas and to information in servo areas, in which the protrusion has a structure in which a first metal layer, a silicon layer and a second metal layer are stacked on the substrate and a metal oxide film is formed on a surface of the protrusion.

The above referenced passages involve a method of manufacturing a master plate for producing a stamper, comprising: depositing a first metal layer, a silicon (Si) layer and a second metal layer on a substrate; applying an electron beam resist to the second metal layer; writing patterns corresponding to recording tracks or recording bits in data areas and patterns corresponding to information in servo areas by electron-beam lithography, followed by developing the resist to form patterns of protrusions and recesses; etching the second metal layer by using Ar gas; reactive ion etching the Si layer by using fluorine-containing gas; and exposing surfaces of the second metal layer, the Si layer and the first metal layer to oxygen plasma to form a metal oxide film at various scales.

USPTO filing 62/995,614 employs an Si frame using Sintered and Reaction-Bonded Si₃N₄ (SRBSN) processes.

USPTO patent pending 62/995,614 contains a background section which notes alternate methods of sensor functionality, namely OFiD (i.e., Optical Frequency Identification), which likewise requires alternate methods of interrogation, thereby making the Micro-Track Device (M-TD^{nm}) technology distinct from RFiD and highly compliant resonant diffraction gratings, and methods and use thereof of US-20130279004-A1.

USPTO filing 62/995,614 (M-TD^{nm}) is a technology employing OFiD and Raman scattering (a cumulative process having net effects of scattering photons and changing their frequency). The spectrographic interrogation system that overcomes the optical diffraction limit in Tip-Enhanced Raman Scattering (TERS) is an optical interrogation method (OFiD).

Conversely, US-20130279004-A1 functions thusly:
Highly-compliant polymer-based resonant diffraction gratings, and methods of use thereof, are provided. In one illustrative embodiment, an amount of pressure applied to a grating surface may be determined by straining a grating, adapted to move into a plurality of pitches, to an applied pitch in the plurality of pitches in response to an application of strain onto a surface adjacent the grating. Electromagnetic radiation comprising a plurality of wavelengths may be applied to the grating, and a resonance wavelength, in the plurality of said wavelengths.

The above referenced passage involves a plurality of wavelengths applied to the grating, and a resonance wavelength, in the plurality of wavelengths, identified while the strain is applied to the grating. The amount of strain applied to the grating surface may then be determined based on the resonant wavelength.

USPTO filing 62/995,614 has technological processes grounded in the Lorenz-Mie theory. Lorenz-Mie suggests that this technique's wavelengths are a result of a unique combination of features in the angular spectrum, the finite content of propagating spatial frequencies, a finite content of spatial frequencies, and a peculiar distribution of the phase (or phase-conjugate) wherein:
the effect is a result of the combination of the shape and size of the particle and the refractive index ratio. This is key, because USPTO filing 62/995,614, is based in grounded literature, that has yet, heretofore, been converged in such a way as to be brought to bear upon the problem of micro-/nano-scale tracking devices/systems, such as Micro-Track Device (M-TD^{nm}) technology.

USPTO patent pending 62/995,614 contains a background section which notes alternate methods of sensor functionality, namely OFiD (i.e., Optical Frequency Identification), which likewise requires alternate methods of interrogation, thereby making the Micro-Track Device (M-TD^{nm}) technology distinct from RFiD and charged particle beam exposure of US-20040178170-A1. USPTO filing 62/995,614 (M-TD^{nm}) is a technology employing OFiD and Raman scattering (a cumulative process having net effects of scattering photons and changing their frequency). The spectrographic interrogation system that overcomes the optical diffraction limit in Tip-Enhanced Raman Scattering (TERS) is an optical interrogation method (OFiD).

Conversely, US-20040178170-A1 functions thusly:
A mask blank of various scales is used for the charged particle beam exposure made by employing an SOI substrate having a silicon membrane higher reliability in quality, without the problem of deformation due to the compression stress of a silicon oxide film as an intermediate layer of the SOI substrate, and provides a method for forming a mask blank and a mask used for the charged particle beam exposure.

The above referenced passages involve a mask blank used for the charged particle beam exposure made by employing an SOI substrate having a front-side silicon membrane and a back-side silicon layer with a silicon oxide layer interposed therebetween is characterized in that the back-side silicon layer and the silicon oxide film of said SOI substrate are partially removed to form an opening to be an exposed region and an etching stop layer having lower stress is formed in the opening.

USPTO filing 62/995,614 differs from the charged particle beam exposure of US-20040178170-A1 in that we propose employing innovative micro- and nano-fabrication processes; including photolithographic printing of ‘chipless’ sensors. These sensors are interrogated in novel ways, such as Tip-Enhanced Raman Scattering (TERS), an approach to surface-enhanced Raman spectroscopy (SERS) in which enhancement of Raman scattering occurs at the point of an instrument (i.e., a ‘tip’). Tip-enhanced Raman spectroscopy employs a Raman microscope coupled with an atomic force microscope; while later variations coupled TERS with a scanning tunneling microscope (STM-TERS). Our approach is a variation of this spectrographic interrogation system that overcomes the optical diffraction limit in TERS. An optical interrogation method of the M-TD is favored, due to the limitations of power at the micro-/nano-scales (hence the OFiD innovation).

The optical diffraction limit, D, is defined as

$$D = k \frac{λ}{NA}$$

Here, λ and NA refer to the optical wavelength and the numerical aperture of the lens, respectively. And k is the factor which depends on the incident beam profile of the lens. For uniform interrogation of the M-TD via an OFiD system, k=˜0.61 (this is the Rayleigh criterion requirement, the generally accepted criteria for the minimum resolvable image or signal fidelity, i.e., 0.61), I realized that k can be varied to as little as 0.36. With k=0.36 and NA=0.9, near-ultraviolet (UV) light (λ=400 nm) can be narrowed to D≈140 nm (tolerances employed in contemporary photolithography; i.e., the microfabrication semiconductors, or semiconductor lithography), while remaining inviolate of the applicable formula. With the same illumination, D=100 nm can be achieved with commercially available technology, such that NA=1.4. This variation in the diffraction limit comports with the formula (something the USPTO will check) and is a variation substantial enough to avoid direct comparative similarity to extant SRS, TERS & STM-TERS patents. As a matter of contingency, literature has revealed the optical diffraction limit of classical optical interrogation can be circumvented via near-field optics. Near-field optics has a variety of applications, including microscopy and spectroscopy, properties of metallic nanostructures, optical nanolithography and optical antennas (the latter being a key component of the interrogation mechanism in M-TD, per the OFiD revision).

There are two radiation types in spectroscopy we will consider: Rayleigh scattering and Raman scattering (with the latter entailing both Anti-Stokes & Stokes Raman Scattering). Rayleigh scattering is a process having a net effect of changing the direction of light, with constant frequency constant (=no exchange of energy). Raman scattering, on the other hand, is a process having net effects of scattering photons and changing their frequency. This manipulation of frequency provides a ‘carrier wave’ for M-TD interrogation via Raman spectroscopy.

Mathematical analyses are used to model the scattering process. The polarizability of materials a, (the key factor for Raman scattering), represents the ability of an applied electric field E to induce a dipole moment μᵢₙ in a substrate. μᵢₙ can be expressed as

μᵢₙ=αE

Suppose the polarizability is α₀ at a material's equilibrium nuclear geometry. At some distance, Δr, away from this equilibrium nuclear geometry, the instantaneous polarizability α is given by

$$α = {α}_{0} + ( \frac{\partial β}{\partial r} ) Δ r$$

Here, the derivative,

$$( \frac{\partial α}{\partial r} ) .$$

represents the change in polarizability with change in position. If the material is vibrating in a sinusoidal fashion, Δr can be expressed as a sinusoidal function in terms of the vibration frequency v and the time t:

Δr=rₘₐₓ cos(2πvt).

Here, rₘₐₓ is the maximum vibrational amplitude. Likewise, the induced electric field E by the light with a particular frequency vᵢₙ also has sinusoidal (wave-form) behavior:

E=Eₘₐₓ cos(2λvᵢₙt)

Eₘₐₓ is the maximum amplitude of the electric field. Substituting E, α, and Δr into the equation yields:

$${μ}_{in} = {α}_{0} {E}_{max} cos ( 2 π {v}_{in} t ) + {E}_{max} {r}_{max} ( \frac{\partial α}{\partial r} ) cos ( 2 π vt ) cos ( π {v}_{in} t ) .$$

Three terms from the formula indicate three different types of radiation: Rayleigh scattering (first term, unchanged energy), Anti-Stokes Raman light (second term, higher energy) and Stokes Raman light (third term, lower energy). The last two terms show that incoming interrogating photons will shift their frequencies via Raman scattering (i.e., the basis of Raman spectroscopy). The Raman scattering intensity for a given wavelength and observation angle is dependent on the incident power, the scattering volume and the Raman cross section of the material. Specific intensity, L, defined as the number of Raman photons scattered from 1 cm²×1 sec, can be described by

L=P_{D}βDₛK

Here, β is the Raman cross section, Dₛ is the frequency (in cm³), P_{D} is the power density (in optical/photonic cm² second), and K is the penetration depth of the laser interrogator. Surface Enhanced Raman Spectroscopy (SERS) is a surface sensitive technique that results in the enhancement of Raman scattering. The enhancement factor can be as much as 10¹⁴-10¹⁵, so this technique is sensitive enough to detect the micro-/nano-scaled M-TD device we are proposing.

USPTO patent pending 62/995,614 contains a background section which notes alternate methods of sensor functionality, namely OFiD (i.e., Optical Frequency Identification), which likewise requires alternate methods of interrogation, thereby making the Micro-Track Device (M-TD^{nm}) technology distinct from RFiD magnetic recording media, method of manufacturing the same and magnetic recording apparatus functionality of US-20050219730-A1.

USPTO filing 62/995,614 (M-TD^{nm}) is a technology employing OFiD and Raman scattering (a cumulative process having net effects of scattering photons and changing their frequency). The spectrographic interrogation system that overcomes the optical diffraction limit in Tip-Enhanced Raman Scattering (TERS) is an optical interrogation method (OFiD).

Conversely, US-20050219730-A1 functions thusly:
The structure of the non-signal section in the burst region is not limited to those shown. For example, it is possible to form the magnetic film on the entire surface of the non-signal section in the burst region. The medium devised employs the use of ‘grown’ Au nanowires as a conductive filler. However, literature suggests these nanowires are too thin (˜2 nm) rendering them brittle and contain long chain capping agents preventing electron transfer between wires. Literature further suggests the aqueous synthesis of citrate nanoparticles eliminates potential toxic organic molecules found in other Au nanoparticle synthesis protocols, such that the Au nanoparticles expressed diameters of 14±2.1 nm, characterized by UV-Vis spectroscopy and Dynamic Light Scattering (DLS). Furthermore, cationic polyurethane was diluted in deionized water to 1 vol. % preceding rapid addition to the Au nanoparticle solution. Following, flocculation with Au nanoparticles occurred instantaneously, changing the properties in such as way as to favorable to Micro-Track Device (M-TD^{nm}) production and functionality.

USPTO filing 62/995,614 may employ polyurethane in production processes, as this displays a strong positive charge allowing for a robust ionic interaction to be formed with the anionic Au nanoparticles. With the addition of polyurethane, the nanocomposite adopts its softer properties, giving the films more tissue compliant features. Following synthesis of the nanocomposite, detailed characterizations were performed to understand nanocomposite properties.

Nanocomposites exhibit a metallic appearance and mechanical flexibility. The close proximity of nanoparticles provides a pathway for electrons to travel.

USPTO patent pending 62/995,614 contains a background section which notes alternate methods of sensor functionality, namely OFiD (i.e., Optical Frequency Identification), which likewise requires alternate methods of interrogation, thereby making the Micro-Track Device (M-TD^{nm}) technology distinct from RFiD and system and methods for determining molecules using mass spectrometry and related techniques of US-20110204219-A1.

USPTO filing 62/995,614 (M-TD^{nm}) is a technology employing OFiD and Raman scattering (a cumulative process having net effects of scattering photons and changing their frequency). The spectrographic interrogation system that overcomes the optical diffraction limit in Tip-Enhanced Raman Scattering (TERS) is an optical interrogation method (OFiD).

Conversely, US-20110204219-A1 functions thusly:
Mass spectrometry and related techniques to determine single species using mass spectrometry. In certain instances, polymers such as DNA or RNA can also be sequenced. Certain embodiments of the invention relate to passing a polymer, such as DNA, RNA, a protein, a polypeptide, a polysaccharide, etc., through a pore and cleaving the polymer in sequence.

The above referenced passages involve how a polymer may be cleaved using a laser or an electric field. In some embodiments, a property of at least one subunit of a polymer is determined using mass spectrometry. In some embodiments, a single ion (which may be a subunit of a polymer, or an ion based on another species) can be isolated in a mass spectrometer and a signal generated from the single ion.

USPTO filing 62/995,614 proposes to use Raman spectroscopy (which can be employed to provide a structural fingerprint by which particulate can be identified). Raman spectroscopy is a type of vibrational spectroscopy technique that can be varied, such that the variation employed in Micro-Track Device (M-TD^{nm}) technology differs from US-20110204219-A1.

Advantages of Raman scanning include:
Non-destructive analysis/interrogation
High spatial resolution (even at sub-micron scale)
Can be measured through a barrier (glass has been tested and confirmed)
Rapid scanning interrogation

USPTO filing 62/995,614 proposes that Micro-Track Device (M-TD^{nm}) technology will employ an optical interrogation method due to the limitations of power at the micro-/nano-scales (hence the OFiD innovation).

USPTO patent pending 62/995,614 contains a background section which notes alternate methods of sensor functionality, namely OFiD (i.e., Optical Frequency Identification), which likewise requires alternate methods of interrogation, thereby making the Micro-Track Device (M-TD^{nm}) technology distinct from RFiD and the plasma polymerized electron beam resist functionality of US-20030203648-A1.

USPTO filing 62/995,614 (M-TD^{nm}) is a technology employing OFiD and Raman scattering (a cumulative process having net effects of scattering photons and changing their frequency). The spectrographic interrogation system that overcomes the optical diffraction limit in Tip-Enhanced Raman Scattering (TERS) is an optical interrogation method (OFiD).

Conversely, US-20030203648-A1 functions thusly:
A process for producing a pattern of negative electron beam resist comprises depositing a layer of plasma polymerized fluoropolymer on a face of a substrate, the plasma polymerized fluoropolymer forming the negative electron beam resist; producing an electron beam; moving the electron beam on the layer of plasma polymerized fluoropolymer to define the pattern, the layer then having exposed fluoropolymer areas defining the pattern and unexposed fluoropolymer areas; and removing the unexposed fluoropolymer areas to leave only the pattern on the face of the substrate.

The above referenced passages involve a process comprising depositing the layer of negative electron beam resist on a face of a substrate; producing an electron beam; moving the electron beam on the layer of negative electron beam resist to define the pattern, the layer then having exposed resist areas defining the pattern and unexposed resist areas; treating the patterned layer with a base solution to decrease a dry etch resistance of the unexposed resist areas; and dry etching the unexposed resist areas to leave only the pattern on the face of the substrate.

USPTO filing 62/995,614 employs a realistic and feasible M-TD ‘variation’ of plasma polymerized electron beam resist functionality, which can be synthesized via semiconducting nanostructures for flexible and large-area electronics. Large-area electronics (LAE) is a conceptual framework for understanding and growing platform for developing the next generation of human-computer interfaces (HCIs). These systems aim to provide unobtrusive services through interfaces that do not rely on the user/target providing active and explicit inputs. The words ‘large area’ in LEA is not intended to convey scale of the devices produced via flexible, large-area electronics using semiconducting nanostructures.

Semiconducting nanostructures such as nanowires have been used as building blocks for various types of sensors, energy storage and generation devices, electronic devices and for new manufacturing methods involving low-cost ‘printed’ nanowires. Complimentary to semiconducting nanostructures are the slightly larger optical fibers. In a single-mode optical fiber, and in fact in all silica-based optical fibers, minimal material dispersion occurs naturally at a wavelength of approximately 1.3 μm. Single-mode fibers can be silica-based, and thusly present an opportunity for reduced production costs of the M-TD³. The minimum-loss window of Single-mode fibers is ˜1.55 μm. The engineering tradeoff of choosing silica-based optical fibers as component parts of the M-TD³ over semiconducting nanostructures such as nanowires is a slight increase in the attenuation coefficient. The rate of diminution of average power with respect to distance along a transmission path is the attenuation coefficient. However, at these scales the difference in power usage is negligible.

USPTO patent pending 62/995,614 contains a background section which notes alternate methods of sensor functionality, namely OFiD (i.e., Optical Frequency Identification), which likewise requires alternate methods of interrogation, thereby making the Micro-Track Device (M-TD^{nm}) technology distinct from RFiD and the Raman-active taggants and recognition functionality of US-20020025490-A1.

USPTO filing 62/995,614 (M-TD^{nm}) is a technology employing OFiD and Raman scattering (a cumulative process having net effects of scattering photons and changing their frequency). The spectrographic interrogation system that overcomes the optical diffraction limit in Tip-Enhanced Raman Scattering (TERS) is an optical interrogation method (OFiD).

Conversely, US-20020025490-A1 functions thusly:
An organic or organoelement, linear or branched, monomeric or polymeric composition of matter having a Raman-active component in the form of particles. The particles having a maximum dimension of 50 μm. The Raman-active compound is applied to a substrate. When the Raman-active compound is exposed to a laser light wavelength which is batochromically well beyond a spectral region of maximum absorbance of said Raman-active compound, Raman scattering can be detected.

USPTO filing 62/995,614, like US-20020025490-A1, uses light scattering as a mechanism to produce an optical signal in particle tracking. Particle size determines scattering regime, from Rayleigh scattering for particles with sizes much smaller than the wavelength of light, to Mie scattering for larger particles with sizes comparable to the wavelength of light. In Rayleigh scattering, scattering intensity varies as the square of the volume of the particle, giving an R⁶ dependence for spherical particles of geometric radius R. In this case, absorbed and scattered light have the same wavelength, and perfectly spherical particles maintain the polarization of light. Darkfield microscopy is a common technique to increase signal-to-noise ratio in such measurements, and as such could also be employed to differentiate USPTO filing 62/995,614 from US-20020025490-A1. Light scattering has some advantages for particle tracking. The short effective lifetime of the excited state results in an emission rate with a high value of saturation. Noble metal nanoparticles scatter light with intensity and have particularly large scattering cross-sections at plasmon resonance. Illumination at a wavelength corresponding to this resonance peak maximizes the scattering signal of the nanoparticle relative to the background noise. The high photostability of such particles means that loss of signal is not usually a concern. Unlike fluorescent nanoparticles, organoelement, linear or branched, monomeric or polymeric composition requiring low irradiance or control over oxygen concentration to limit photobleaching, the practical limit on the maximum useful irradiance for scattering particles results from particle heating. Heat transfer to the local environment of the particle, as in processes inherent in the validated claims of US-20020025490-A1 can perturb the sample and bias the measurement.

The statistics of the emission of photons from a particle is another optical property that can improve spatial resolution is key to USPTO filing 62/995,614. In particular, a sub-Poissonian distribution of photon emission allows resolution of adjacent emitters below the diffraction limit. Such a distribution, for example, Bernoulli's distribution, has a smaller variance than a Poisson distribution with the same mean value. Quantifying missing photon coincidences between emitters/sensors improves the resolution in comparison to the classical Poisson photon distribution. Sub-Poissonian anti-bunched emission from quantum dots allows super resolved images of a static sample. The missing three-photon coincidence signal enables a spatial resolution that is two thirds of the diffraction limit of a tracking apparatus with an EMCCD camera, or the optical interrogation method (OFiD) in USPTO filing 62/995,614. This indicates USPTO patent pending 62/995,614 contains a background section which notes alternate methods of sensor functionality, namely OFiD (i.e., Optical Frequency Identification), which likewise requires alternate methods of interrogation, thereby making the Micro-Track Device (M-TD^{nm}) technology distinct from RFiD and the Raman optical identification tag production and functionality of US-20050225758-A1.

USPTO filing 62/995,614 (M-TD^{nm}) is a technology employing OFiD and Raman scattering (a cumulative process having net effects of scattering photons and changing their frequency). The spectrographic interrogation system that overcomes the optical diffraction limit in Tip-Enhanced Raman Scattering (TERS) is an optical interrogation method (OFiD).

Conversely, US-20050225758-A1 functions thusly:
A method for tagging and identifying a composition using Raman spectroscopy is disclosed, the method comprising tagging the composition by disbursing additional individual tag molecules throughout a base material thereof so as to create a tagged material having a spectral profile with a specific Raman optical signature encoded therein, wherein the specific Raman optical signature of the tagged material is distinct from the native Raman optical signature of the base material; and identifying the composition by reading a spectral response of the tagged material with a Raman spectroscopic technique so as to identify the composition based on the specific Raman optical signature encoded in the tagged material rather than the native Raman optical signature encoded in the base material.

The above referenced passages involve a preferred embodiment of the present invention, wherein there is provided a method in which additional Raman scattering peaks are superimposed into the Raman spectrum of the native material through the introduction of additional individual tag molecules interspersed, on a molecular level, throughout the base bulk material during its manufacture. These additional molecules of one or more substances create a tagged material for the purpose of encoding manufacturing and other traceability information. The Raman spectral profile of the tagged material is obtained in the field so as to determine the encoded information therein, which in turn relates to the manufacturing and other traceability information. Preferably, traditional Raman spectroscopy techniques are used to excite and detect both the Raman spectrum of the base material and the Raman spectrum of the added molecules superimposed on the Raman spectrum of the base material, which together encode the manufacturing the feasibility of improved temporal bandwidth in comparison to photoactivated localization microscopy and comparable spatial resolution by using even higher order missing coincidences (particularly with fluorescent nanoparticles, organoelement, linear or branched, monomeric or polymeric composition).

USPTO patent pending 62/995,614 contains a background section which notes alternate methods of sensor functionality, namely OFiD (i.e., Optical Frequency Identification), which likewise requires alternate methods of interrogation, thereby making the Micro-Track Device (M-TD^{nm}) technology distinct from RFiD and the programmable molecular barcodes production and functionality of US-20050064435-A1.

USPTO filing 62/995,614 (M-TD^{nm}) is a technology employing OFiD and Raman scattering (a cumulative process having net effects of scattering photons and changing their frequency). The spectrographic interrogation system that overcomes the optical diffraction limit in Tip-Enhanced Raman Scattering (TERS) is an optical interrogation method (OFiD).

Conversely, US-20050064435-A1 functions thusly:
In certain embodiments of the invention, the barcodes comprise polymer backbones that may contain one or more branch structures. Tags may be attached to the backbone and/or branch structures. The barcode may also comprise a probe that can bind to a target, such as proteins, nucleic acids and other biomolecules or aggregates. Different barcodes may be distinguished by the type and location of the tags. In other embodiments, barcodes may be produced by hybridization of one or more tagged oligonucleotides to a template, comprising a container section and a probe section.

The above referenced passages involve the tagged oligonucleotides may be designed as modular code sections, to form different barcodes specific for different targets. In alternative embodiments, barcodes may be prepared by polymerization of monomeric units. Bound barcodes may be detected by various imaging modalities, such as, surface plasmon resonance, fluorescent or Raman spectroscopy.

USPTO filing 62/995,614 works via an optical interrogation method (OFiD) of Micro-Track Device (M-TD^{nm}), whereas US-20050064435-A1 functions by means of proteins, nucleic acids and other biomolecules or aggregates binding to a target, such as ‘molecular barcodes’, interrogated via various imaging modalities, such as, surface plasmon resonance, fluorescent or Raman spectroscopy. identification tag. These techniques include, but are not limited to, spontaneous Raman spectroscopy, stimulated Raman spectroscopy, Raman difference spectroscopy, surface enhanced Raman spectroscopy, etc.

USPTO filing 62/995,614 requires a zero-dispersion wavelength regiment (i.e., minimum-dispersion wavelength) and nano-scale single-mode optical fiber as connective tissue from the E-beam resist layer to the Si frame of the M-TD^{nm} device. This approach capitalizes upon the phenomena wherein the wavelength or wavelengths at which material dispersion occurs and waveguide dispersion transpires cancel one another. In all silica-based optical fibers, minimum material dispersion occurs naturally at a wavelength of approximately 1.3 μm. Single-mode fibers may be made of silica-based glasses containing dopants that shift the material-dispersion wavelength, and thus, the zero-dispersion wavelength, toward the minimum-loss window at approximately 1.55 μm. The engineering tradeoff is a slight increase in the minimum attenuation coefficient. In a multimode optical fiber, the wavelength at which material dispersion is minimum, i.e., essentially zero. The rate of diminution of average power with respect to distance along a transmission path is the attenuation coefficient, and as such, is not a concern.

USPTO patent pending 62/995,614 contains a background section which notes alternate methods of sensor functionality, namely OFiD (i.e., Optical Frequency Identification), which likewise requires alternate methods of interrogation, thereby making the Micro-Track Device (M-TD^{nm}) technology distinct from RFiD and the IC production and functionality of US-20170024510-A1.

USPTO filing 62/995,614 (M-TD^{nm}) is a technology employing OFiD and Raman scattering (a cumulative process having net effects of scattering photons and changing their frequency). The spectrographic interrogation system that overcomes the optical diffraction limit in Tip-Enhanced Raman Scattering (TERS) is an optical interrogation method (OFiD).

Conversely, US-20170024510-A1 functions thusly:
The simulation transformation function A⁻¹ roughly correlates to an inverse of the mask process correction transformation function A and is represented in FIG. 2 as A⁻¹. It will be recognized that the simulation transformation function is not precisely the inverse function of the mask process correction transformation function as otherwise, the shapes in (a) and (c) of FIG. 2 would be the same. Data representing a 2D contour in (c) may be expressed by a 2D function Ψ(x, y), similar to the shape represented by the MTO design
After the MPC is performed, a topology check may be performed (S135). The topology check may mean a process of checking a phase effect of a mask.
After the topology check is performed, a fracture may be performed (S140). The fracture may mean a fracturing the mask process corrected data for each region and converting a format of the fractured mask process corrected data into a format for an electron beam exposure apparatus. The fracture may include, for example, a data manipulation such as scaling, sizing of data, rotating of data, pattern reflection, or a color inversion.
During a conversion of data through the fracture, data about systematic errors may be corrected, the systematic errors occurring at the time of transferring design data to an image on a wafer. Therefore, the fracture may function to supplement a function of the MPC. In some cases, the fracture may be performed before the MPC is performed.
After the fracture is performed, an MPC verification may be performed (S150). The MPC verification may be as described above and performed by outputting a mask pattern in a 2D contour shape obtained through a simulation using a mask process model and comparing a 2D contour with a MTO shape obtained from the MTO design data.
After the MPC verification is performed, an optical proximity correction (OPC) verification may be performed (S160).
After the pixel data is generated, an exposure process, that is, an electron beam writing may be performed (S230). The electron beam writing may mean that an electron beam is irradiated on a mask substrate, that is, a mask plate or mask blank based on the pixel data.
The mask plate or mask blank may have a structure in which an opaque thin film such as chromium is coated on a transparent base layer such as glass or fused silica. Before the exposure process is performed, a resist film having a strong etch resistance may be coated on the chromium, and in the electron beam writing, the electron beam may be irradiated on a resist film in a predetermined pattern based on the pixel data.
The electron beam writing may be performed through a variable shape beam (VSB) exposure process and a gray exposure process using a multi-beam mask writer (MBMW). Of course, the electron beam writing is not limited to the VSB exposure process and the gray exposure process using the MBMW.

The above referenced passages involve chip finishing processes and outcomes which include custom designations and structures to improve manufacturability and functionality of the layout. data described above. The 2D functions describing the MTO shape and the 2D contour (respectively Ψ₀(x₀, y₀) and Ψ(x, y)) need not be in the same graphic data. For example, the 2D function Ψ₀(x₀, y₀) describing the MTO shape may be derived from MTO design data. The 2D function Ψ(x, y) may be derived from a manufacturing simulation (such as applying a simulation transformation function A⁻¹) to a 2D function Ψₘ(xₘ, yₘ) that was derived from the mask process corrected data.
After the 2D contour is output, (d) of FIG. 2 illustrates that the 2D contour obtained via simulation is compared with the shape represented by the MTO design data. The comparing may be performed on all of positions of a pattern or may be performed only on certain designated positions of the pattern. For example, in (d) of FIG. 2, the comparing may be performed only on positions indicated by black points.
When a difference between the shape obtained by the MTO design data and the 2D contour is determined to be within an allowable range through the comparing, the MPC verification may be ended. In other words, it may be considered that MPC accuracy is confirmed within a predetermined degree (and may indicate that the pattern elements of the mask to be manufacture will not deviate from the corresponding pattern elements represented by the MTO design data by more than a predetermined threshold or predetermined degree).
However, when the difference between the shape obtained by the MTO design data and the 2D contour is determined to be outside the allowable range, the mask process model may be adjusted from which make a new mask process correction function may be derived. The new mask process correction function may be generated using a new mask process model that reflects an altered manufacturing recipe and which is used in the subsequent mask manufacturing simulation in view of the new, mask process corrected data obtained from the new mask process correction function being applied to the MTO design data. The MPC, the outputting of the 2D contour, and the comparing may be repeated until the MPC accuracy is confirmed to be within a predetermined degree. The mask process model and the mask process correction function A may continue to be adjusted such that a value of Σ [Ψ₀(x₀, y₀)−Ψ(x, y)]² is minimized (or made smaller than an acceptable threshold value) with respect to these 2D functions described herein.

Note that the layout-to-mask preparation that enhances layout data and adjusts the data to mask production devices. This step includes resolution enhancement technologies (RET), such as optical proximity correction (OPC) which corrects for the wave-like behavior of light when etching the nano scale features of the most modern integrated circuits.

USPTO filing 62/995,614 employs the Lorentz-Drude model to solve the problem arising from the conventional optical physics models in which only the surface effect is accounted for. The Drude dispersive model for surface plasmons (coherent but delocalized electron oscillations that exist at the interface between any two materials, wherein the real part of the dielectric function changes pos+/neg− orientation, across the interface) in the frequency domain can be recombinant in the Lorentz-Drude model, expressed as

$${ε}_{r} ( ω ) = {ε}_{∞} + {\sum }_{m = 1}^{N} \frac{{χ}_{0} {G}_{m} {ω}_{0 m}^{2}}{{ω}_{0 m}^{2} + i {Γ}_{m} ω - {ω}^{2}} , {\sum }_{m = 1}^{N} {G}_{m} = 1$$

wherein:
ω₀ₘ are the resonant frequencies
Gₘ is related to the oscillator strengths
Γₘ is the damping coefficient
ε_{∞} is the permittivity at infinite frequency
X₀ is the permittivity at ω=0
   such that the complex dielectric function, εᵣ(ω), will be based upon the Lorentz-Drude model in the frequency domain. Lorentz-Drude model is the key to OFiD as an integrated aspect of M-TD to enhance the surface sensitivity of OFiD spectroscopic measurements via Raman scattering, as enhanced by surface plasmons.

### BRIEF SUMMARY OF THE INVENTION

Micro-Tracking Device (M-TD^{nm}) is a micro-scale technology employing OFiD and Raman scattering (a cumulative process having net effects of scattering photons and changing their frequency). This manipulation of frequency provides a ‘carrier wave’ for M-TD^{nm} interrogation via Raman spectroscopy. The spectrographic interrogation system that overcomes the optical diffraction limit in Tip-Enhanced Raman Scattering (TERS) is an optical interrogation method (OFiD). Said method can be enhanced for tracking & spatial location precision of the M-TD^{nm} device via photonic microscopy (i.e., light scattering) such as interferometric scattering microscopy (iSCAT). This refers to a class of methods that detect and image a subwavelength object by interfering the light scattered by it with a reference light field, thus serving as another mechanism to produce an optical signal in nano-to-micro-scale particle tracking.

### BRIEF DESCRIPTION OF THE SEVERAL VIEWS OF THE DRAWINGS

The following figure descriptions relate to the drawings found in the ‘Drawings’ section:

FIG. 1 shows the M-TD^{nm} aerial perspective, with an outer 6 nm×6 nm substrate layer, and an internal scale of 2 nm×0.67 nm composed of 2 μm I/O (input/output of Raman spectroscopy & OFiD); 1 μm conduction band, and a membrane.

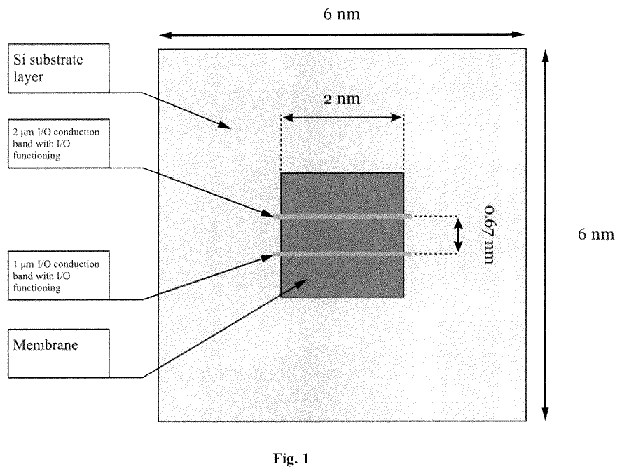

FIG. 2 shows the M-TD^{nm} in lateral perspective: E-beam resist layer with Si substrate layer (1.75 nm thick), adhesion layer (0.20 nm thick), membrane layer (0.30 nm thick), and Si frame (1.75 nm in height).

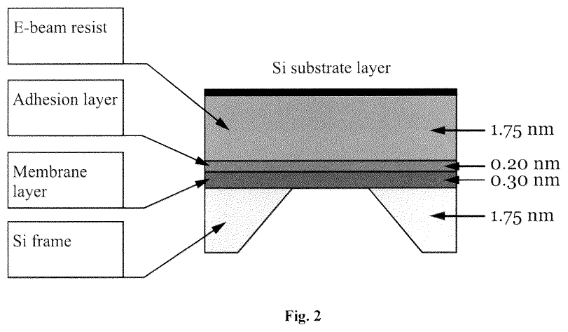

FIG. 3 shows the M-TD^{nm} isometric view perspective, composed of E-beam resist layer (1.75 nm), with an outer 6 nm×6 nm substrate, and an internal scale of 2 nm×0.67 nm composed of 2 μm I/O (input/output of Raman spectroscopy & OFiD), 1 μm conduction band with I/O function, an adhesion layer (0.20 nm), membrane layer (0.20 nm), and Si frame (1.75 nm).

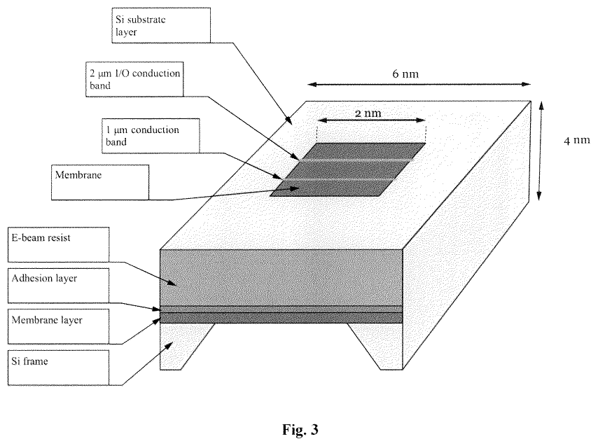

### DETAILED DESCRIPTION OF THE INVENTION

RFiD tags, as a rule, contain an integrated circuit and an antenna, which are used to transmit data to the RFiD reader (or interrogator). Passive tags do not have an active transmitter that communicates with the interrogator, but rather typically couple the transmitter to the receiver with either load-modulation or backscatter (this is near-field/far-field dependent, meaning the proximity of the tag to the of the interrogator). Coupling is the process of transference of energy from one medium to another; passive tags use coupling to obtain power and transfer data. The type of coupling used, inductive or backscatter (also known as radiative), depends on the frequency and the distance between the tag and the interrogator. The boundary between the near-field and far-field is λ/2π (where λ=wavelength). Within the near-field, the magnetic field intensity decays rapidly as 1/d³ (d=distance between the interrogator antenna and the tag). When the magnetic field strength is ultimately translated into power available to the tag, the power attenuates according to 1/d⁶. The magnetic field strength is thus high in the immediate vicinity of the transmitting antenna, but its level is reduced to being negligible in the far-field. In the far-field the power at the tag is attenuated to 1/d². RFiD systems operating at 125-135 kHz and 13.56 MHz operate in the near-field and use inductive coupling, while those operating beyond 100 MHz (e.g., 860-960 MHz and 2400 and 5800 MHz) operate in the far-field and use backscatter (radiative) coupling. The wavelength of the frequency ranges used in inductively coupled RFID system (135 kHz: 2400 m; 13.56 MHz: 22.1 m) is much more than the conductor length in any standard interrogator antenna. It is also many times greater than the distance between the interrogator antenna and the tag antenna. Therefore, the electromagnetic field may be considered as conceptually equivalent to a simple magnetic alternating field with regard to the distance between tag and antenna. The interrogator communicates with the tag by modulating a carrier wave by varying the amplitude (i.e., the phase, or frequency) of the carrier. This modulation can be directly detected as current changes in the coil of the tag. The tag communicates with the interrogator by varying the degree to which the interrogator mechanism loads its antenna. This, in turn, affects the voltage across the interrogator's antenna, which can create sideband frequencies via load-switching on/off in a pattern when coupled into the interrogator antenna. Tags operating at UHF and microwave frequencies use far-field and couple with the interrogator using backscatter. The amount of energy received at the receiver decreases as an inverse of the square of the distance (d) between the interrogator antenna and tag (1/d²).

As a matter of physics, an electromagnetic field propagates outward from the interrogator-antenna, and a proportion of that field (reduced by attenuation) reaches the tag's antenna. The power is supplied to the antenna as high-frequency voltage, and after rectification it can be used to power the tag (or activate/deactivate the tag). Some proportion of the incoming RF energy is reflected by the antenna and reradiated outward into free-space. The amount of energy reflected depends on how well the antenna couples to the electromagnetic wave. RFiD tags that use backscatter to interact with their interrogators have antennas that are designed to resonate well with the carrier signal emitted by the interrogator. The reflection characteristics of the antenna (i.e., the cross-section efficacy), can be mitigated by altering the load connected to the antenna. To transmit data from the tag to the interrogator, a load resistor connected in parallel with the antenna is switched on/off in synchronization with the data stream to be transmitted. The resonant properties of the antenna determine if the tag is an efficient or inefficient reflector. This varies with the strength of the signal reflected from the tag, creating a pattern that is detected at the interrogator as data. This technique is referred to as modulated backscatter. Before the backscattered signal arrives at the interrogator antenna, it experiences forward and backward path loss, interferences in both directions, and absorption by the tag. The reflected signal also travels into the antenna connection of the interrogator in the reverse direction from the original signal. It is decoupled using a directional coupler and is transferred to the receiver input of the interrogator. The forward signal of the transmitter is, likewise, suppressed by the directional coupler.

Further addressing limitations of RFiD, for an RFiD system operating at 13.56 MHz, the approximate distance at which the near-field zone ends is λ/2π, or 3.5 meters. Beyond this distance, the magnetic field is reduced so low that tags cannot be powered. Due to this, the typical read range for 13.56 MHz tags is less than 1 meter. The read distance depends on the size of the interrogator antenna. Typical handheld interrogators can read an electronic identity from ˜2 inches. An interrogator with a large antenna can read a tag up to 2 feet away; where inductive RFiD systems are operated in the near-field, interference from adjacent systems is lower compared to radiatively coupled systems.

While inductive coupling uses near-field effects, backscatter coupling uses far-field effects. Near-and far-field effects are different mechanisms for the transfer of energy through (free) space. In the quantum view of electromagnetic interactions (i.e., interactions at the nano-scale), far-field effects are manifestations of real photons, whereas near-field effects are due to a mixture of real and virtual photons. Virtual photons composing near-field fluctuations and signals have effects that are of shorter range than those of real photons. The reliable nature of quantum-field effects will be capitalized upon as a mechanism for OFiD (i.e., Optical Frequency Identification) which requires alternate methods of interrogation, such as those found in ‘chipless’ RFiD sensor-interrogation (i.e., interrogation executed via Raman Scattering/Raman spectroscopy). Raman spectroscopy is commonly employed to provide a structural fingerprint by which particulate can be identified. Raman spectroscopy is a type of vibrational spectroscopy technique that can be varied. Advantages of Raman scanning include: non-destructive analysis/interrogation; high spatial resolution (even at sub-micron scale); measurement through a barrier; and rapid scanning interrogation (˜10 m/sec to 1 sec exposure to obtain a Raman spectrum reading). The magnitude of the Raman effect correlates with polarizability of the electrons in the M-TD^{nm}.

The component parts of the M-TD^{nm} including Si (silicone molecule) substrate, conduction band, and membrane, provides for an ‘E-beam resist’ function. E-beam resists (electron beam resists) are designed for electron beam applications, are used in electron beam direct writing and multilayer processes, and have effective adhesion with silicon. E-beam resists can be coded in such a way as to provide a unique identifier. Electron spectroscopy refers to a group of analytical techniques of emitted electron energies. Raman spectroscopy is a spectroscopic technique based on Raman scattering. When a substance interacts with the laser beam, the photons from the laser beam interact with molecules, exciting the electrons. The Raman spectrum reading will be interpreted via an optical frequency identification (OFiD). The OFiD employs a laser beam to interact with the molecules of the M-TD's E-beam resist layer, exciting the electrons in order to ‘read’ the output of the interrogation event. The interrogation output is the unique identifier associated with the coded E-beam resist layer.

M-TD^{nm} Power-Scheme

While energy harvesting profiles of the M-TD^{nm} will include kinetic, thermal, vibration and electromagnetic radiation energy harvesting, the following update will focus entirely on electromagnetic energy harvesting, as this is the most ubiquitous, consistent, proliferating and persistent source of energy for passive harvesting.

Electromagnetic energy can be captured from a variety of ambient RF sources which generate high electromagnetic fields. Radio signals have a wide frequency range from 300 GHz to as low as 3 kHz, which are used as a medium to carry energy in the form of electromagnetic radiation. This form of energy harvesting is suitable for powering a larger number of devices distributed in a wide area. The harvested power from various RF sources is between 1 μW to −189 μW at a frequency of around 900 MHz, and a distance of 5 m to 4.1 km. The energy harvesting rate varies significantly depending on the source power and distances involved, however the M-TD^{nm} will operate beyond said tolerances when integrated with IOT.

The M-TD^{nm} wireless energy harvesting power scheme proposes the following energy profiles and approaches to micro- and nano-scale devices.

| | Internal | Power | Device | |
|---|---|---|---|---|
| Frequency | Resistance | Density | Volume | |
| (Hz) | (Ω) | (μW/nm³) | (nm³) | Functions |
| 840/1070/ | 626 | 0.157/0.014/ | 0.035 | 3 modes & multiple |
| 1490 | | 0.117 | | frequencies. |
| | | | | Integrates well with |
| | | | | MEMS* |
| | | | | Scalable to nano-. |
| 10 | 1.19 | 2187.5 max. | 160 | Works at low |
| | | | | frequencies |

*MEMS (micro-electromechanical system) - a miniature machine that has both mechanical and electronic components. The physical dimension of MEMS can range from several millimeters (mm) to <1 μm (1 micrometer), a dimension many times smaller than the width of a human hair.

Semiconducting nanostructures such as nanowires have been used as building blocks for various types of sensors, energy storage and generation devices, electronic devices and for new manufacturing methods involving low-cost ‘printed’ nanowires. Complimentary to semiconducting nanostructures are the slightly larger optical fibers. In a single-mode optical fiber, and in fact in all silica-based optical fibers, minimal material dispersion occurs naturally at a wavelength of approximately 1.3 μm. The minimum-loss window of single-mode fibers is ˜1.55 μm. When using silica-based optical fibers as component parts of the M-TD^{nm} over semiconducting nanostructures such as nanowires there is a slight increase in the attenuation coefficient, though in power usage difference is negligible. The rate of diminution of average power with respect to distance along a transmission path (i.e., the attenuation coefficient) is negligible precisely because of the small scale.

Light scattering is the key mechanism to produce the optical signal in M-TD^{nm} tracking. M-TD^{nm} size determines scattering regime, from Rayleigh scattering for particles with sizes much smaller than the wavelength of light, to Mie scattering for larger particles with sizes comparable to the wavelength of light (in the event of upscaled variations of the M-TD^{nm} from nano- to micro-scale). In Rayleigh scattering, scattering intensity varies commensurate with the square of the volume of the particle (in this case the M-TD^{nm} device).

The best mode of M-TD^{nm} is asset automated supply chain tool & logistics asset management.

### REFERENCE MATERIALS

Ahmed, I., Khoo, E. H., Kurniawan, O., & Li, E. P. (2011). Modeling and simulation of active plasmonics with the FDTD method by using solid state and Lorentz-Drude dispersive model. JOSA B, 28(3), 352-359.
Ahmad, M., Anguita, J. V., Stolojan, V., Carey, J. D. and Silva, S. R. P., “Efficient coupling of optical energy for rapid catalyzed nanomaterial growth: high-quality carbon nanotube synthesis at low substrate 91 temperatures,” ACS Appl. Mater. Inter, vol. 5, no. 9, pp. 3861-3866, May 8, 2013.
Ahmad, M., “Carbon nanotube based integrated circuit interconnects,” University of Surrey, Faculty of Engineering and Physical Sciences, Department of Electronic Engineering Thesis (Ph.D.)—University of Surrey, 2013. Google Scholar
Ahmad, M., et al., “High quality carbon nanotubes on conductive substrates grown at low temperatures,” Adv. Funct. Mater, vol. 25, no. 28, pp. 4419-4429, 2015.
Ahn, J. H., et al., “Heterogeneous three-dimensional electronics by use of printed semiconductor nanomaterials,” Science, vol. 314, no. 5806, pp. 1754-1757, 2006.
Ago, H., Nakamura, K., Uehara, N., and Tsuji, M., “Roles of metal-support interaction in growth of single- and double-walled carbon nanotubes studied with diameter-controlled iron particles supported on MgO,” J. Phys. Chem. B, vol. 108, no. 49, pp. 18908-18915, Dec. 9, 2004.
Agrawal, G. P., & Potasek, M. J. (1986). Nonlinear pulse distortion in single-mode optical fibers at the zero-dispersion wavelength. Physical Review A, 33(3), 1765.
Aguet, F., Geissbuhler, S., Marki, I., Lasser, T. and Unser, M., Optical Expressions. 17(8), 6829-6848 (2009). https://doi.org/10.1364/OE.17.006829.
Akinwande, D., Petrone, N. and Hone, J., “Two-dimensional flexible nanoelectronics,” Natural Communications, vol. 5, p. 5678, 2014.
Akutsu, M., Koyasu, K., Atobe, J., Miyajima, K., Mitsui, et al. (2017). Geometric and electronic properties of Si-atom doped Al clusters: robustness of binary superatoms against charging. Physical Chemistry Chemical Physics, 19(31), 20401-20411.
Alenezi, M. R., Henley, S. J., Emerson, N. G. and Silva, S. R. P., “From 1D and 2D ZnO nanostructures to 3D hierarchical structures with enhanced gas sensing properties,” Nanoscale, vol. 6, no. 1, pp. 235-247, 2014.
Alexandrescu, R., et al., “Synthesis of carbon nanotubes by CO2-laser-assisted chemical vapour deposition,” Infrared. Phys. Techn., vol. 44, no. 1, pp. 43-50, February 2003.
Allen, J. E., et al., “High-resolution detection of Au catalyst atoms in Si nanowires,” Nat. Nanotechnol., vol. 3, no. 3, pp. 168-173, 2008.
Alsunaidi, M. A., & Al-Jabr, A. A. (2009). A general ADE-FDTD algorithm for the simulation of dispersive structures. IEEE Photonics Technology Letters, 21(12), 817-819.
Amato, M. Palummo, M., Rurali, R. and Ossicini, S., “Silicon-germanium nanowires: chemistry and physics in play, from basic principles to advanced applications,” Chem. Rev., vol. 114, no. 2, pp. 1371-1412, 2013.
Ambrose, E. J., Nature 178, 1194 (1956). https://doi.org/10.1038/1781194a0
Anazawa, K., et al., “High-purity carbon nanotubes synthesis method by an arc discharging in magnetic field,” Appl. Phys. Lett., vol. 81, no. 4, pp. 739-741, July 2002.
Ando, Y., “Carbon nanotube: the inside story,” J. Nanosci. Nanotechno., vol. 10, no. 6, pp. 3726-3738, June 2010.
Anguita, J. V., et al., “Highly transmissive carbon nanotube forests grown at low substrate temperature,” Adv. Funct. Mater., 2013.
Ainslie, B., & Day, C. (1986). A review of single-mode fibers with modified dispersion characteristics. Journal of Lightwave Technology, 4(8), 967-979.
Ando, Y., Zhao, X. Sugai, T., and Kumar, M., “Growing carbon nanotubes,” Mater. Today., vol. 7, no. 10, pp. 22-29, 2004.
Andre, P. S., Pinto, A. N., and Pinto, J. L. (2003, September). Effect of temperature on the single mode fibers chromatic dispersion. In Proceedings of the 2003 SBMO/IEEE MTT-S International Microwave and Optoelectronics Conference-IMOC 2003. (Cat. No. 03TH8678) (Vol. 1, pp. 231-234). IEEE.
Ashfold, M. R. N., Doherty, R. P., Ndifor-Angwafor, N. G., Riley, D. J., and Sun, Y., “The kinetics of the hydrothermal growth of ZnO nanostructures,” Thin Solid Films, vol. 515, no. 24, pp. 8679-8683, October 2007.
Arbiol, J., et al., “Influence of Cu as a catalyst on the properties of silicon nanowires synthesized by the vapour-solid-solid mechanism,” Nanotechnology, vol. 18, no. 30, p. 305606, 2007.
Archambault, A., Marquier, F., Greffet, J. J., & Arnold, C. (2010). Quantum theory of spontaneous and stimulated emission of surface plasmons. Physical Review B, 82(3), 035411.
Arnold, M. S., Green, A. A., Hulvat, J. F., Stupp, S. I., and Hersam, M. C., “Sorting carbon nanotubes by electronic structure using density differentiation,” Nat. Nanotechnol., vol. 1, p. 60, 2006.
Astrom, K. J. & Murray, R. M., Feedback Systems: An Introduction for Scientists and Engineers (Princeton University Press, Princeton, New Jersey, USA, 2008).
Awad, Y., Lavallée, É., Beauvais, J., & Drouin, D. (2005). U.S. Pat. No. 6,855,646. Washington, DC: U.S. Patent and Trademark Office.
Azam, M. A., Manaf, N. S. A., Talib, E., and Bistamam, M. S. A., “Aligned carbon nanotube from catalytic chemical vapor deposition technique for energy storage device: a review,” Ionics, vol. 19, no. 11, pp. 1455-1476, 2013.
Babcock, H. W., Science 249, 253-257 (1990). https:/doi.org/10.1126/science.249.4966.253 Bachtold, A., et al., “Aharonov-Bohm oscillations in carbon nanotubes,” Nature, vol. 397, no. 6721, pp. 673-675, 1999.
Bandow, S., Rao, A. M., Williams, K. A., Thess, A., Smalley, R. E. and Eklund, P. C., “Purification of single-wall carbon nanotubes by microfiltration,” J. Phys. Chem. B, Letter vol. 101, no. 44, pp. 8839-8842, October 1997.
Baron, T., et al., “Si nanowire growth and characterization using a microelectronics-compatible catalyst: PtSi,” Appl. Phys. Lett., vol. 89, no. 23, p. 233111, 2006.
Benavides-Cruz, M., Calderón-Ramón, C., Gomez-Aguilar, J. F., Rodriguez-Achach, M., Cruz-Orduña, I., Laguna-Camacho, J. R., . . . & Juárez-Morales, G. (2016). Numerical simulation of metallic nanostructures interacting with electromagnetic fields using the Lorentz-Drude model and FDTD method. International Journal of Modern Physics C, 27(04), 1650043.
Bayer, B. C., et al., “Co-catalytic solid-state reduction applied to carbon nanotube growth,” J. Phys. Chem. B, vol. 116, no. 1, pp. 1107-1113, Jan. 12, 2012.
Bootsma, G. & Gassen, H., “A quantitative study on the growth of silicon whiskers from silane and germanium whiskers from germane,” J. Cryst. Growth, vol. 10, no. 3, pp. 223-234, 1971.
Bolshakov, A. P., et al., “A novel CW laser-powder method of carbon single-wall nanotubes production,” Diam. Relat. Mater., vol. 11, no. 3-6, pp. 927-930, March-June 2002.
Boskovic, B. O., Stolojan, V., Khan, R. U., Haq, S. and Silva, S. R. P., “Large-area synthesis of carbon nanofibers at room temperature,” Nat. Mater., vol. 1, no. 3, pp. 165-168, 2002.
Bower, C., Zhu, W., Jin, S. H. and Zhou, O., “Plasma-induced alignment of carbon nanotubes,” Appl. Phys. Lett., vol. 77, no. 6, pp. 830-832, August 2000.
Bumb, A., Sarkar, S. A., Billington, N., Brechbiel, M. W. and Neuman, K. C., Journal of American Chemical Society. 135, 7815-7818 (2013). https://doi.org/10.1021/ja4016815
Cao, L. et al., “Instability and transport of metal catalyst in the growth of tapered silicon nanowires,” Nano Lett., vol. 6, no. 9, pp. 1852-1857, 2006.
Chan, C. K., Zhang, X. F. and Cui, Y., “High-capacity Li ion battery anodes using Ge nanowires,” Nano Lett., vol. 8, no. 1, pp. 307-309, 2008.
Chang, P. C. & Lu, J. G., “ZnO nanowire field-effect transistors,” IEEE. T. Electron. Dev., vol. 55, no. 11, pp. 2977-2987, November 2008.
Chen, R., Du, X., Cui, Y., Zhang, X., Ge, Q., Dong, J., & Zhao, X. (2020). Vertical flow assay for inflammatory biomarkers based on nanofluidic channel array and SERS nanotags. Small, 16(32), 2002801.
Chen, G. Y., Jensen, B., Stolojan, V., and Silva, S. R. P., “Growth of carbon nanotubes at temperatures compatible with integrated circuit technologies,” Carbon, vol. 49, no. 1, pp. 280-285, January 2011.
Chen, X., Wong, C. K., Yuan, C. A. and Zhang, G., “Nanowire-based gas sensors,” Sens. Actuator B-Chem., vol. 177, pp. 178-195, 2013.
Chhowalla, M., et al., “Growth process conditions of vertically aligned carbon nanotubes using plasma enhanced chemical vapor deposition,” J. Appl. Phys., vol. 90, no. 10, pp. 5308-5317, Nov. 15, 2001.
Choi, S. Y., Fung, W. Y., and Lu, W., “Growth and electrical properties of Al-catalyzed Si nanowires,” Appl. Phys. Lett., vol. 98, no. 3, p. 033108, 2011.
Choi, M. C, Kim, Y. and Ha, C. S., “Polymers for flexible displays: From material selection to device applications,” Progressive Polymer Sci., vol. 33, no. 6, pp. 581-630, 2008.
Chojnowski, J. (1991). Kinetically controlled siloxane ring-opening polymerization. Journal of Inorganic and Organometallic Polymers, 1(3), 299-323.
Chou, T. P., Zhang, Q. F., Fryxell, G. E., and Cao, G. Z., “Hierarchically structured ZnO film for dye-sensitized solar cells with enhanced energy conversion efficiency,” Adv. Mater., vol. 19, no. 18, September 2007.
Chu, S. W., T. Y. Su, R. Oketani, Y. T. Huang, H.-Y. Wu, Y. Yonemaru, M. Yamanaka, H. Lee, G. Y. Zhuo, M.-Y. Lee, S. Kawata, and K. Fujita, Physical Review Letters. 112, 017402 (2014). https://doi.org/10.1103/PhysRevLett.112.017402
Chishima, T., Miyagi, Y., Wang, X., Yamaoka, H., Shimada, H., Moossa, M. R. and Hoffman, R. M., Cancer Research. 57, 2042-2047 (1997).
Croissant, J. G., Cattoën, X., Durand, J. O., Man, M. W. C., & Khashab, N. M. (2016). Organosilica hybrid nanomaterials with a high organic content: syntheses and applications of silsesquioxanes. Nanoscale, 8(48), 19945-19972.
Colas, A. (2005). Silicones: preparation, properties and performance. Dow Corning, Life Sciences.
Colbert, D. T., et al., “Growth and sintering of fullerene nanotubes,” Science, vol. 266, no. 5188, pp. 1218-1222, November 1994.
Collins, P. G., Arnold, M. S., and Avouris, P., “Engineering carbon nanotubes and nanotube circuits using electrical breakdown,” Science, vol. 292, no. 5517, p. 706, 2001.
Cui, Y. & Lieber, C M., “Functional nanoscale electronic devices assembled using silicon nanowire building blocks,” Science, vol. 291, no. 5505, pp. 851-853, 2001.
Dahiya, R., Gottardi, G. and Laidani, N., “PDMS residues-free micro/macrostructures on flexible substrates,” Microelectron. Eng., vol. 136, pp. 57-62, 2015.
Dahiya, R. S., Adami, A., Collini, C. and Lorenzelli, L., “Fabrication of single crystal silicon micro-/nanostructures and transferring them to flexible substrates,” Microelectron. Eng., vol. 98, pp. 502-507, 2012.
Dai, H. J., et al., “Controlled chemical routes to nanotube architectures, physics, and devices,” (in English), J. Phys. Chem. B, vol. 103, no. 51, pp. 11246-11255, December 1999.
Dai, Z. R., Pan, Z. W. and Wang, Z. L., “Novel nanostructures of functional oxides synthesized by thermal evaporation,” Adv. Funct. Mater, vol. 13, no. 1, pp. 9-24, 2003.
Dang, W., et al., “Printable stretchable interconnects,” Flex. Print. Electron., vol. 2, no. 1, p. 013003, 2017.
Dasgupta, N. P., et al., “25th anniversary article: semiconductor nanowires-synthesis, characterization, and applications,” Adv. Mater., vol. 26, no. 14, pp. 2137-2184, 2014.
Dastmalchi, B., Tassin, P., Koschny, T., & Soukoulis, C. M. (2016). A new perspective on plasmonics: confinement and propagation length of surface plasmons for different materials and geometries. Advanced Optical Materials, 4(1), 177-184.
Dienerowitz, M., Mazilu, M., & Dholakia, K. (2008). Optical manipulation of nanoparticles: a review. Journal of Nanophotonics, 2(1), 021875.
Dresselhaus, M. S., Dresselhaus, G., and Avouris, P., Carbon nanotubes: synthesis, structure, properties, and applications, Springer Books 2001.
Dresselhaus, M. S., Jorio, A. and Saito, R., “Characterizing graphene, graphite, and carbon nanotubes by raman spectroscopy,” in Annu. Rev. Conden. Ma. P, vol. 1, 2010, pp. 89-108.
Dresselhaus, M. S., Dresselhaus, G., Saito, R. and Jorio, A., “Raman spectroscopy of carbon nanotubes,” Phys. Rep., vol. 409, no. 2, pp. 47-99, March 2005.
Duan, W. H., Wang, Q. and Collins, F., “Dispersion of carbon nanotubes with SDS surfactants: a study from a binding energy perspective,” Chem. Sci., vol. 2, no. 7, pp. 1407-1413, 2011.
Dubrovskii, V., Sibirev, N., and Cirlin G., “Kinetic model of the growth of nanodimensional whiskers by the vapor-liquid-crystal mechanism,” Tech. Phys. Lett., vol. 30, no. 8, pp. 682-686, 2004.
Ebbesen, T. W. & Ajayan, P. M., “Large-scale synthesis of carbon nanotubes,” Nature vol. 358, pp. 220-222, 1992.
Ebbesen, T. W., Ajayan, P. M., Hiura, H. and Tanigaki, K., “Purification of nanotubes,” Nature, Letter vol. 367, no. 6463, pp. 519-519, February 1994.
Eggeling, C., Volkmer, A. and Seidel, C. A. M., (2005). Chemistry & Physical Chemistry. 6, 791-804. https://doi.org/10.1002/cphc.200400509
Eklund, P. C., et al., “Large-scale production of single-walled carbon nanotubes using ultrafast pulses from a free electron laser,” Nano Lett., vol. 2, no. 6, pp. 561-566, June 2002.
Eldlio, M., Che, F., & Cada, M. (2014). Drude-Lorentz model of semiconductor optical plasmons. In IAENG Transactions on Engineering Technologies (pp. 41-49). Springer, Dordrecht.
End, M., et al., “The production and structure of pyrolytic carbon nanotubes (PNTs),” J. Phys. Chem. Solids., vol. 54, no. 12, pp. 1841-1848, December 1993.
Esconjauregui, S., et al., “Growth of ultrahigh density vertically aligned carbon nanotube forests for interconnects,” ACS Nano, vol. 4, no. 12, pp. 7431-7436, December 2010.
Fan, H. J., F. Bertram, A. Dadgar, J. Christen, A. Krost, and M. Zacharias, “Self-assembly of ZnO nanowires and the spatial resolved characterization of their luminescence,” Nanotechnology, vol. 15, no. 11, p. 1401, 2004.
Fan, Z., et al., “Toward the development of printable nanowire electronics and sensors,” Adv. Mater., vol. 21, no. 37, pp. 3730-3743, 2009.
Fan, F. R., Tian, Z. Q. and Wang, Z. L., “Flexible triboelectric generator,” Nano Energy, vol. 1, no. 2, pp. 328-334, 2012.
Fan, H. J., et al., “Semiconductor nanowires: from self-organization to patterned growth,” Small, vol. 2, no. 6, pp. 700-717, 2006.
Fan, Y. W., Goldsmith, B. R., and Collins, P. G., “Identifying and counting point defects in carbon nanotubes,” Nat. Mater., vol. 4, no. 12, pp. 906-911, December 2005.
Farhat, S., et al., “Diameter control of single-walled carbon nanotubes using argon-helium mixture gases,” J. Chem. Phys., vol. 115, no. 14, pp. 6752-6759, October 2001.
Fett, T., Fanfschilling, S., Hoffmann, M. J., Oberacker, R., Jelitto, H., & Schneider, G. A. (2008). R-Curve Determination for the Initial Stage of Crack Extension in Si3N4. Journal of the American Ceramic Society, 91(11), 3638-3642.
Finkelstein, H., & Learmonth, T. (2017). U.S. patent application Ser. No. 15/415,685.
Foland, S. J., & Lee, J. B. (2016). U.S. Pat. No. 9,234,991. Washington, DC: U.S. Patent and Trademark Office.
Fowler, B., Liu, C., Mims, S., Balicki, J., Li., W., Do, H., Appelbaum, J. and Vu, P., (2010). Procedural SPIE 7536, 753607. https://doi.org/10.1117/12.846975
Frank, S., Poncharal, P., Wang, Z. L. and de Heer, W. A., “Carbon nanotube quantum resistors” (in English), Science, vol. 280, no. 5370, pp. 1744-1746, June 1998.
Froberg, L., Seifert, W., and Johansson, J., “Diameter-dependent growth rate of InAs nanowires,” Phys. Rev. B, vol. 76, no. 15, p. 153401, 2007.
Fu, R., Zhang, K., Zaccaria, R. P., Huang, H., Xia, Y., & Liu, Z. (2017). Two-dimensional silicon suboxides nanostructures with Si nanodomains confined in amorphous SiO2 derived from siloxene as high-performance anode for Li-ion batteries. Nano Energy, 39, 546-553.
Fuhrmann, B., H. S. Leipner, H.-R. Höche, L. Schubert, P. Werner, and U. Gösele, “Ordered arrays of silicon nanowires produced by nanosphere lithography and molecular beam epitaxy,” Nano Lett., vol. 5, no. 12, pp. 2524-2527, 2005.
Gao, P. X. and Wang, Z. L., “Nanopropeller arrays of zinc oxide,” Appl. Phys. Lett., vol. 84, no. 15, pp. 2883-2885, 2004.
Gao, X., Xiao, Z., & Ning, L. (2010, December). Surface plasmons enhanced super-resolution focusing of radially polarized beam. In Advances in Optoelectronics and Micro/nano-optics (pp. 1-4). IEEE.
Garcia Nunez, C., Navaraj, W. T., Liu, F., Shakthivel, D. and R. Dahiya, R., “Large-area self-assembly of silica microspheres/nanospheres by temperature-assisted dip-coating,” ACS Appl. Mater. Inter, vol. 10, no. 3, pp. 3058-3068, 2018.
Garnett, E. C., Brongersma, M. L., Cui, Y. and McGehee, M. D., “Nanowire solar cells,” Ann. Rev. Mater. Res., vol. 41, pp. 269-295, 2011.
Gedney, S. D. (2011). Introduction to the finite-difference time-domain (FDTD) method for electromagnetics. Synthesis Lectures on Computational Electromagnetics, 6(1), 1-250.
Gamalski, G., C. Ducati, and S. Hofmann, “Cyclic supersaturation and triple phase boundary dynamics in nanowire growth,” J. Phys. Chem. B, vol. 115, no. 11, pp. 4413-4417, 2011.
Givargizov, E. I. & Sheftal, N. N., “Morphology of silicon whiskers grown by the VLS-technique,” J. Cryst. Growth, vol. 9, no. 0, pp. 326-329, 5, 1971.
Goldberger, J., Fan, R. and Yang, P., “Inorganic nanotubes: a novel platform for nanofluidics,” Accounts Chem. Res., vol. 39, no. 4, pp. 239-248, 2006.
Gopinath, A., Boriskina, S. V., Feng, N. N., Reinhard, B. M., & Negro, L. D. (2008). Photonic-plasmonic scattering resonances in deterministic aperiodic structures. Nano letters, 8(8), 2423-2431.
Gouesbet, G. (2014). Latest achievements in generalized Lorenz-Mie theories: A commented reference database. Annalen der Physik, 526(11-12), 461-489.
Govender, K., Boyle, D. S., Kenway, P. B. and O'Brien, P., “Understanding the factors that govern the deposition and morphology of thin films of ZnO from aqueous solution,” J. Mater. Chem., vol. 14, no. 16, pp. 2575-2591, 2004.
Greene, L. E., et al., “Low-temperature wafer-scale production of ZnO nanowire arrays,” Angew. Chem. Int. Edit., vol. 42, no. 26, pp. 3031-3034, 2003.
Guo, T., et al., “Uranium stabilization of C28—a tetravalent fullerene,” Science, vol. 257, no. 5077, pp. 1661-1664, September 1992.
Guozhong, C. (2004). Nanostructures and nanomaterials: synthesis, properties and applications. World Scientific.
Han, H., Huang, Z., and Lee, W., “Metal-assisted chemical etching of silicon and nanotechnology applications,” Nano Today, vol. 9, no. 3, pp. 271-304, 2014.
Hannon, J, Kodambaka, S., Ross, F., and Tromp, R., “The influence of the surface migration of gold on the growth of silicon nanowires,” Nature, vol. 440, no. 7080, pp. 69-71, 2006.
Hata, K., et al., “Water-assisted highly efficient synthesis of impurity-free single-waited carbon nanotubes,” Science, vol. 306, no. 5700, pp. 1362-1364, Nov. 19, 2004.
Harutyunyan, A. R., et al., “Preferential growth of single-walled carbon nanotubes with metallic conductivity,” Science, vol. 326, no. 5949, p. 116, 2009.
Hayden, O., Agarwal, R. and Lu, W., “Semiconductor nanowire devices,” Nano Today, vol. 3, no. 5-6, pp. 12-22, 2008.
Hobbs, R. G., Petkov, N., and Holmes, J. D., “Semiconductor nanowire fabrication by bottom-up and top-down paradigms,” Chem. Mater., vol. 24, no. 11, pp. 1975-1991, 2012.
Hodes, G., “When small is different: some recent advances in concepts and applications of nanoscale phenomena,” Adv. Mater., vol. 19, no. 5, pp. 639-655, 2007.
Hitchman, M. L. & Jensen, K. F., Chemical vapor deposition: principles and applications. Elsevier, 1993.
Hofmann, S., et al., “In situ observations of catalyst dynamics during surface-bound carbon nanotube nucleation,” Nano Lett., vol. 7, no. 3, pp. 602-608, 2007.
Hofmann, S., et al., “Ledge-flow-controlled catalyst interface dynamics during Si nanowire growth,” Nat. Mater., vol. 7, no. 5, p. 372, 2008.
Hong, J. I., Bae, J., Wang, Z. L., and Snyder, R. L., “Room-temperature, texture-controlled growth of ZnO thin films and their application for growing aligned ZnO nanowire arrays,” Nanotechnology, vol. 20, no. 8, p. 5, February 2009.
Huang, F., Hartwich, T. M. P., Rivera-Molina, F. E., Lin, U., Duim, W. C., Long, J. J., Uchil, P. D., Myers, J. R., Baird, M. A., Mothes, W., Davidson, M. W., Toomre, D. and Bewersdorf, J., (2013) Natural Methods 10(7), 653-658. https://doi.org/10.1038/nmeth.2488
Huang, M. H., et al., “Catalytic growth of zinc oxide nanowires by vapor transport,” Adv. Mater., vol. 13, no. 2, pp. 113-116, 2001.
Huang, M. H., Wu, Y., Feick, H., Tran, N., Weber, E. and Yang, P., “Catalytic growth of zinc oxide nanowires by vapor transport,” Adv. Mater., vol. 13, no. 2, pp. 113-116, 2001.
Hynecek, J. & Nishiwaki, T., IEEE Trans. Electron Devices 50(1), 239-245 (2003). https://doi.org/10.1109/TED.2002.806962
Iijima, S., “Helical Microtubules of Graphitic Carbon,” Nature, vol. 354, no. 6348, pp. 56-58, November 1991.
Ippolito, S. B., Goldberg, B. B., & Ünlü, M. S. (2005). Theoretical analysis of numerical aperture increasing lens microscopy. Journal of Applied Physics, 97(5), 053105.
Ishii, H., et al., “Direct observation of Tomonaga-Luttinger-liquid state in carbon nanotubes at low temperatures,” Nature, vol. 426, no. 6966, pp. 540-544, December 2003.
Jain, P. K., Lee, K. S., I. H. El-Sayed, and M. A. El-Sayed, J. Phys. Chem. B. 110, 7238-7248 (2006). https://doi.org/10.1021/jp057170o
Javey, A., Guo, J., Wang, Q., Lundstrom, M. and Dai, H. J., “Ballistic carbon nanotube field-effect transistors,” Nature, vol. 424, no. 6949, pp. 654-657, August 2003.
Javey, A., Nam, S., Friedman, R. S., Yan, H. and Lieber, C. M., “Layer-by-layer assembly of nanowires for three-dimensional, multifunctional electronics,” Nano Lett., vol. 7, no. 3, pp. 773-777, 2007.
Ji, N., Milkie, D. E., and Betzig, E., Natural Methods. 7(2), 141-147 (2010). https://doi.org/10.1038/nmeth.1411
Johansson, J., Wacaser, B. A., Dick, K. A, and Seifert, W., “Growth related aspects of epitaxial nanowires,” Nanotechnology, vol. 17, no. 11, p. S355, 2006.
Jones, A. R. (1999). Light scattering for particle characterization. Progress in Energy and Combustion Science, 25(1), 1-53.
Jung, S. H., et al., “High-yield synthesis of multi-walled carbon nanotubes by arc discharge in liquid nitrogen,” Applied Physics. A-Mater., vol. 76, no. 2, pp. 285-286, February 2003.
Jung, Y. J., Wei, B. Q., Vajtai, R., and Ajayan, P. M., “Mechanism of selective growth of carbon nanotubes on SiO2/Si patterns,” Nano Lett., vol. 3, no. 4, pp. 561-564, April 2003.
Kalache, B., i Cabarrocas, P. R., and i Morral, A. F., “Observation of incubation times in the nucleation of silicon nanowires obtained by the vapor-liquid-solid method,” Jpn. J. Appl. Phys., vol. 45, no. 2L, p. L190, 2006.
Kamins, T., Li, X., Williams, R. S., and X. Liu, X., “Growth and structure of chemically vapor deposited Ge nanowires on Si substrates,” Nano Lett., vol. 4, no. 3, pp. 503-506, 2004.
Kamata; Yoshiyuki; et al. (2010). Master Plate and Method of Manufacturing the Same. U.S. patent application Ser. No. 12/712,045.
Karch, A. (2011). Surface plasmons and topological insulators. Physical Review B, 83(24), 245432.
Kang, S. J., et al., “High-performance electronics using dense, perfectly aligned arrays of single-walled carbon nanotubes,” Nat. Nanotechnol., vol. 2, no. 4, p. 230, 2007.
Khan, S., Dahiya, R. S. and Lorenzelli, L., “Flexible thermoelectric generator based on transfer printed Si microwires,” in Solid State Device Research Conference (ESSDERC), 2014 44th European, 2014, pp. 86-89: IEEE.
Kashchiev, D., “Dependence of the growth rate of nanowires on the nanowire diameter,” Cryst. Growth. Des., vol. 6, no. 5, pp. 1154-1156, 2006.
Keçili, R., Büytiktiryaki, S., & Hussain, C. M. (2019). Advancement in bioanalytical science through nanotechnology: past, present and future. TrAC Trends in Analytical Chemistry, 110, 259-276.
Khan, S., Lorenzelli, L., and Dahiya, R. S., “Technologies for printing sensors and electronics over large flexible substrates: a review,” IEEE. Sens. J., vol. 15, no. 6, pp. 3164-3185, 2015.
Khan, S., Yogeswaran, N., et al., “Flexible FETs using ultrathin Si microwires embedded in solution processed dielectric and metal layers,” J. Micromech. Microeng., vol. 25, no. 12, p. 125019, 2015.
Khan, S., Lorenzelli, L. and Dahiya, R., “Flexible MISFET devices from transfer printed Si microwires and spray coating,” IEEE. J. Electron. Devi., vol. 4, no. 4, pp. 189-196, 2016.
Khalaf, M. M., Ibrahimov, H. G., and Ismailov, E. H., “Nanostructured materials: importance, synthesis and characterization—a review,” Chemistry Journal vol. 2, no. 3, pp. 118-125, 2012.
Kim, D. H., et al., “Stretchable and foldable silicon integrated circuits,” Science, vol. 320, no. 5875, pp. 507-511, 2008.
Kim, S. J., Choi, K., Lee, B., Kim, Y. and Hong, B. H., “Materials for flexible, stretchable electronics: graphene and 2D materials,” Ann. Rev. Mater. Res., vol. 45, pp. 63-84, 2015.
Kim, B., et al., “Kinetics of individual nucleation events observed in nanoscale vapor-liquid-solid growth,” Science, vol. 322, no. 5904, pp. 1070-1073, 2008.
Ko, S. H., et al., “Nanoforest of hydrothermally grown hierarchical ZnO nanowires for a high efficiency dye-sensitized solar cell,” Nano Lett., vol. 11, no. 2, pp. 666-671, 2011.
Knopp, K., Vakhshoori, D. and Rhodes, G., (2005). Raman optical identification tag. US Patent No. US2005/0225758 A1.
Kodambaka, S., et al., “Diameter-independent kinetics in the vapor-liquid-solid growth of Si nanowires,” Phys. Rev. Lett., vol. 96, no. 9, p. 096105, 2006.
Kolb, F., et al., “Analysis of silicon nanowires grown by combining SiO evaporation with the VLS mechanism,” J. Electrochem. Soc., vol. 151, no. 7, pp. G472-G475, 2004.
Kong, J., Soh, H. T., Cassell, A. M., Quate, C. F. and Dai, H. J., “Synthesis of individual single-walled carbon nanotubes on patterned silicon wafers,” Nature, vol. 395, no. 6705, pp. 878-881, October 1998.
Kong, J., Cassell, A. M. and Dai, H. J., “Chemical vapor deposition of methane for single-walled carbon nanotubes,” Chem. Phys. Lett., vol. 292, no. 4-6, pp. 567-574, August 1998.
Kong, J., et al., “Quantum interference and ballistic transmission in nanotube electron waveguides,” Phys. Rev. Lett., vol. 87, no. 10, p. 4, September 2001, Art. no. 106801.
Kosemura, D., & Ogura, A. (2010). Transverse-optical phonons excited in Si using a high-numerical-aperture lens. Applied Physics Letters, 96(21), 212106.
Kreupl, F., et al., “Carbon nanotubes in interconnect applications,” Microelectron. Eng., vol. 64, no. 1-4, pp. 399-408, October 2002.
Krot, H. W., et al., “C-60—Buckminsterfullerene,” (in English), Nature, vol. 318, no. 6042, pp. 162-163, 1985.
Krupke, R., Hennrich, F., Löhneysen, H., and Kappes, M. M., “Separation of metallic from semiconducting single-walled carbon nanotubes,” Science, vol. 301, no. 5631, p. 344, 2003.
Kudlinski, A., George, A. K., Knight, J. C., Travers, J. C., Rulkov, A. B., Popov, S. V., & Taylor, J. R. (2006). Zero-dispersion wavelength decreasing photonic crystal fibers for ultraviolet-extended supercontinuum generation. Optics Express, 14(12), 5715-5722.
Kumar, M. & Ando, Y., “Chemical vapor deposition of carbon nanotubes: a review on growth mechanism and mass production,” J. Nanosci. Nanotechno., vol. 10, no. 6, pp. 3739-3758, June 2010.
Kumar, M. & Ando, Y., “A simple method of producing aligned carbon nanotubes from an unconventional precursor—Camphor,” Chem. Phys. Lett., vol. 374, no. 5-6, pp. 521-526, Jun. 18, 2003.
Kwiat, M., Cohen, S., Pevzner, A., Patolsky, F., “Large-scale ordered 1D-nanomaterials arrays: Assembly or not?,” Nano Today, vol. 8, no. 6, pp. 677-694, 2013.
Laidler, K. J., Chemical Kinetics. Delhi: Pearson Education, 2008. Google Scholar.
Lackowicz, J. R., Principles of Fluorescence Spectroscopy, 3 ed. (Springer, 2006).
Lau, P. H., et al., “Fully printed, high performance carbon nanotube thin-film transistors on flexible substrates,” Nano Lett., vol. 13, no. 8, pp. 3864-3869, 2013.
Lee, K. H., Ahmed, I., Goh, R. S. M., Khoo, E. H., Li, E. P., & Hung, T. G. G. (2011). Implementation of the FDTD method based on Lorentz-Drude dispersive model on GPU for plasmonics applications. Progress In Electromagnetics Research, 116, 441-456.
Lee, K. Y., et al., “Vertically aligned growth of carbon nanotubes with long length and high density,” J. Vac. Sci. Technol. B., vol. 23, no. 4, pp. 1450-1453, July-August 2005.
Lienig, J. & Scheible J., (2020). “Chap. 3.3: Mask Data: Layout Post Processing”. Fundamentals of Layout Design for Electronic Circuits. Springer. pp. 102-110. (ISBN 978-3-030-39284-0) Lim, K., Ropp, C., Shapiro, B., Taylor, J. M. and Waks E., Nano Letters. 15, 1481-1486 (2015). https://doi.org/10.1021/nl503280u
Liu, H., Nishide, D., Tanaka, T., and Kataura, H., “Large-scale single-chirality separation of single-wall carbon nanotubes by simple gel chromatography,” Nat. Commun., vol. 2, p. 309, 2011.
Liu, Z., Xu, J., Chen, D. and Shen, G., “Flexible electronics based on inorganic nanowires,” Chem. Soc. Rev., vol. 44, no. 1, pp. 161-192, 2015.
Liu, X., Atwater, M., Wang, J. and Huo, Q., (2007). Colloids Surf. B 58, 3-7. https://doi.org/10.1016/j.colsurfb.2006.08.00
Liveri, V. T., Controlled synthesis of nanoparticles in microheterogeneous systems. Springer Science & Business Media, 2006.
Long, F., Zeng, S. and Huanf, Z. L., (2012) Optical Expressions. 20(16), 17741-17759. https://doi.org/10.1364/OE.20.017741
Lauhon, L. J., Gudiksen, M. S., Wang, D. and Lieber, C. M., “Epitaxial core-shell and core-multishell nanowire heterostructures,” Nature, vol. 420, no. 6911, pp. 57-61, 2002.
Law, M., Greene, L. E., Johnson, J. C., Saykally, R. and Yang, P., “Nanowire dye-sensitized solar cells,” Nat. Mater., vol. 4, p. 455, 2005.
Le, H. Q., Chua, S. J., Loh, K. P., Fitzgerald, E. A. and Koh, Y. W., “Synthesis and optical properties of well aligned ZnO nanorods on GaN by hydrothermal synthesis,” Nanotechnology, vol. 17, no. 2, pp. 483-488, January 2006.
Lee, J. H., “Gas sensors using hierarchical and hollow oxide nanostructures: overview,” Sens. Actuator B-Chem., vol. 140, no. 1, pp. 319-336, June 2009.
Lee, K. H., Ahmed, I., Goh, R. S. M., Khoo, E. H., Li, E. P., & Hung, T. G. G. (2011). Implementation of the FDTD method based on Lorentz-Drude dispersive model on GPU for plasmonics applications. Progress In Electromagnetics Research, 116, 441-456.
Lee, J. S., et al., “Growth of zinc oxide nanowires by thermal evaporation on vicinal Si (100) substrate,” J. Cryst. Growth., vol. 249, no. 1, pp. 201-207, 2003.
Lensch-Falk, J. L., Hemesath E. R., Perea, D. E., and Lauhon, L. J., “Alternative catalysts for VSS growth of silicon and germanium nanowires,” J. Mater. Chem., 10.1039/B817391E vol. 19, no. 7, pp. 849-857, 2009.
Li, J. et al., “Bottom-up approach for carbon nanotube interconnects,” Appl. Phys. Lett, vol. 82, no. 15, pp. 2491-2493, April 2003.
Li, Q., et al., “Sustained growth of ultralong carbon nanotube arrays for fiber spinning,” Adv. Mater., vol. 18, no. 23, pp. 3160-3163, Dec. 4, 2006.
Lieber, C. M. & Wang, Z. L., “Functional nanowires,” MRS Bull., vol. 32, no. 2, pp. 99-108, 2007.
Lieber, C. M., “One-dimensional nanostructures: chemistry, physics & applications,” Solid State Communications, vol. 107, no. 11, pp. 607-616, 1998.
Li, Y., Qian, F, Xiang, J., and Lieber, C. M., “Nanowire electronic and optoelectronic devices,” Mater. Today., vol. 9, no. 10, pp. 18-27, 2006.
Liu, B. & Zeng, H. C., “Hollow ZnO microspheres with complex nanobuilding units,” Chem. Mater., vol. 19, no. 24, pp. 5824-5826, 2007.
Liu, X., et al., “Large-scale integration of semiconductor nanowires for high-performance flexible electronics,” ACS Nano, vol. 6, no. 3, pp. 1888-1900, 2012.
Long, Y. Z., Yu, B., et al., “Recent advances in large-scale assembly of semiconducting inorganic nanowires and nanofibers for electronics, sensors and photovoltaics,” Chem. Soc. Rev., vol. 41, no. 12, pp. 4560-4580, 2012.
Lu, W. & Lieber, C. M., “Nanoelectronics from the bottom up,” Nat. Mater., vol. 6, no. 11, pp. 841-850, 2007.
Luongo, G. (2016). Synthesis and functionalisation of biocompatible magnetic nanomaterials.
Ma, T., M. Guo, M., Zhang, M., Zhang, Y. J., and Wang, X. D., “Density-controlled hydrothermal growth of well-aligned ZnO nanorod arrays,” Nanotechnology, vol. 18, no. 3, p. 7, January 2007.
Maloney, J. G., & Smith, G. S. (1992). The efficient modeling of thin material sheets in the finite-difference time-domain (FDTD) method. IEEE Transactions on antennas and Propagation, 40(3), 323-330.
Maloney, J. G., & Smith, G. S. (1992). The use of surface impedance concepts in the finite-difference time-domain method. IEEE Transactions on antennas and propagation, 40(1), 38-48.
Mangels, J., & Mikijelj, B. (1994). Solid state sintering of silicon nitride ARL-CR-114. Final report (No. ORNL/M-4021). Oak Ridge National Lab., TN (United States); Ceradyne, Inc., Costa Mesa, CA (United States).
Mansoor, R., & AL-Khursan, A. H. (2018). Numerical modelling of surface plasmonic polaritons. Results in Physics, 9, 1297-1300.
Maruyama, S., R. Kojima, R., Miyauchi, Y., Chiashi, S., and Kohno, M., “Low-temperature synthesis of high-purity single-walled carbon nanotubes from alcohol,” Chem. Phys. Lett., vol. 360, no. 3-4, pp. 229-234, Jul. 10, 2002.
Murtensson, T., et al., “Epitaxial III-V Nanowires on Silicon,” Nano Lett., vol. 4, no. 10, pp. 1987-1990, 2004.
Markov, I., “Crystal growth for beginners: fundamentals of nucleation,” Crystal Growth and Epitaxy, p. 69, 1995.
Markovic, M. I., & Rakic, A. D. (1990). Determination of the reflection coefficients of laser light of wavelengths λ∈(0.22 μm, 200 μm) from the surface of materials using the Lorentz-Drude model. Applied optics, 29(24), 3479-3483.
Maruyama, R., Nam, Y. W., Han, J. H. and Strano, M. S., “Well-defined single-walled carbon nanotube fibers as quantum wires: Ballistic conduction over micrometer-length scales,” Curr. Appl. Phys., vol. 11, no. 6, pp. 1414-1418, November 2011.
McAlpine, M. C., Ahmad, H., Wang, D., and Heath, J. R., “Highly ordered nanowire arrays on plastic substrates for ultrasensitive flexible chemical sensors,” Natural Materials, vol. 6, no. 5, p. 379, 2007.
Merkulov, V. I., Lowndes, D. H., Wei, Y. Y., Eres, G., and Voelkl, E., “Patterned growth of individual and multiple vertically aligned carbon nanofibers,” Appl. Phys. Lett., vol. 76, no. 24, pp. 3555-3557, June 2000. CrossRefI Google Scholar
Meshot, E. R., et al., “Engineering vertically aligned carbon nanotube growth by decoupled thermal treatment of precursor and catalyst,” ACS Nano, vol. 3, no. 9, pp. 2477-2486, September 2009.
Millward, D. B., & Stuen, K. (2014). U.S. Pat. No. 8,642,157. Washington, DC: U.S. Patent and Trademark Office.
Minsky, M., “Microscopy apparatus,” U.S. Pat. No. 3,013,467 (19 Dec. 1961). Google Scholar
Moffitt, M. G., (2013). Journal of Physical Chemistry Letters. 4, 3654-3666. https://doi.org/10.1021/jz401814s
Monticone, D. G., Katamadze, K., Traina, P., Moreva, E., Forneris, J., Ruo-Berchera, I., Olivero,
P., Degiovanni, I. P., Brida, G. and Genovese, M., Physical Review Letters. 113, 143602 (2014). https://doi.org/10.1103/PhysRevLett.113.143602
Morales, A M & Lieber, C M., “A laser ablation method for the synthesis of crystalline semiconductor nanowires,” Science vol. 279, no. 5348, pp. 208-11, 1998.
Morimoto, K. (2004). Mask blank for charged particle beam exposure, method of forming mask blank and mask for charged particle beam exposure. U.S. Patent Application No. US2004/0178170 A1.
Müller, M., Rögner, J., Okolo, B., Bauer, W., & Knitter, R. (2010). Processing of micro-components made of sintered reaction-bonded silicon nitride (SRBSN). Part 2: Sintering behaviour and micro-mechanical properties. Ceramics International, 36(2), 707-717.
Mureau, N., Mendoza, E., Silva, S. R. P., Hoettges, K. F. and Hughes, M. P., “In situ and real time determination of metallic and semiconducting single-walled carbon nanotubes in suspension via dielectrophoresis,” Appl. Phys. Lett, vol. 88, no. 24, p. 243109, 2006.
Nathan, A., et al., “Flexible electronics: the next ubiquitous platform,” Proc. IEEE., vol. 100, no. Special Centennial Issue, pp. 1486-1517, 2012.
Nayak, J., Sahu, S. N., Kasuya, J., and Nozaki, S., “Effect of substrate on the structure and optical properties of ZnO nanorods,” J. Phys. D. Appl. Phys., vol. 41, no. 11, p. 6, June 2008.
Nessim, G. D., et al., “Tuning of vertically-aligned carbon nanotube diameter and areal density through catalyst pre-treatment,” Nano Lett., vol. 8, no. 11, pp. 3587-3593, November 2008.
Núñez, C. G., Liu, F., Navaraj, W. T., Christou, A. Shakthivel, D. and Dahiya, R.,
“Heterogeneous integration of contact-printed semiconductor nanowires for high-performance devices on large areas,” Microsyst Nanoeng, vol. 4, no. 1, p. 22, 2018.
Nunez, C. G., Taube, W., Liu, F. and Dahiya, R., “ZnO nanowires based flexible UV photodetectors for wearable dosimetry,” Sensors, 2017 IEEE, 2017, pp. 1-3: IEEE.
Núñez, F. L. C. G., Xu, S. and Dahiya, R., “Large-area electronics based on micro/nanostructures and the manufacturing technologies,” Cambridge Elements (2018), In press.
Painchaud, Y., Poulin, M., Morin, M. and Tetu, M., (2009). Optical Expressions. 17(5), 3659-3672. https://doi.org/10.1364/OE.17.003659
Pal, D., Kowar, M., Daw, A., and Roy, P., “Modelling of silicon epitaxy using silicon tetrachloride as the source,” Microelectr. J., vol. 26, no. 6, pp. 507-514, 1995.
Pan, Z. W., Dai, Z. R., and Wang, Z. L., “Nanobelts of semiconducting oxides,” Science, vol. 291, no. 5510, p. 1947, 2001.
Park, S., Vosguerichian, M., and Bao, Z., “A review of fabrication and applications of carbon nanotube film-based flexible electronics,” Nanoscale, vol. 5, no. 5, pp. 1727-1752, 2013.
Park, W. I., G. C. Yi, M. Y. Kim, and S. J. Pennycook, “ZnO nanoneedles grown vertically on Si substrates by non-catalytic vapor-phase epitaxy,” Adv. Mater., vol. 14, no. 24, pp. 1841-1843, December 2002.
Park, H. H., et al., “Position-controlled hydrothermal growth of ZnO nanorods on arbitrary substrates with a patterned seed layer via ultraviolet-assisted nanoimprint lithography,” Cryst. Eng. Comm., vol. 15, no. 17, pp. 3463-3469, 2013.
Paladugu, M., et al., “Novel growth phenomena observed in axial InAs/GaAs nanowire heterostructures,” Small, vol. 3, no. 11, pp. 1873-1877, 2007.
Patolsky, F., Zheng, G., and Lieber, C. M., “Nanowire-based biosensors,” ed: ACS Publications, Anal. Chem, Vol. 78, no. 13, pp. 4260-4269, 2006.
Pauport\tilde{e}, T., Lincot, D., Viana, B. and Pellé, F., “Toward laser emission of epitaxial nanorod arrays of ZnO grown by electrodeposition,” Appl. Phys. Lett, vol. 89, no. 23, p. 233112, 2006.
Pedelacq, J. D., Cabantous, S., Tran, T., Terwilliger, T. C. and Waldo, G. S., (2006). Natural Biotechnology 24(1), 79-88. https://doi.org/10.1038/nbt1172
Persson, A. I., M. W. Larsson, S. Stenström, B. J. Ohlsson, L. Samuelson, and L. R. Wallenberg, “Solid-phase diffusion mechanism for GaAs nanowire growth,” Nat. Mater., vol. 3, no. 10, pp. 677-681, 2004.
Pitelet, A., Schmitt, N., Loukrezis, D., Scheid, C., De Gersem, H., Ciraci, C., . . . & Moreau, A. (2019). Influence of spatial dispersion on surface plasmons, nanoparticles, and grating couplers. JOSA B, 36(11), 2989-2999.
Petti, L., et al., “Metal oxide semiconductor thin-film transistors for flexible electronics,” Applied Physical Review, vol. 3, no. 2, p. 021303, 2016.
Pinion, C. W., Nenon, D. P., Christesen, J. D., and Cahoon, J. F., “Identifying crystallization- and incorporation-limited regimes during vapor-liquid-solid growth of Si nanowires,” ACS Nano, vol. 8, no. 6, pp. 6081-6088, 2014.
Piruska, A., Nikcevic, I., Lee, S. H., Ahn, C., Heineman, W. R., Limbach, P. A. and Seliskar, C. J., (2005). Lab Chip 5, 1348-1354. https://doi.org/10.1039/b508288a
Polat, E. O., Balci, O., Kakenov, N., Uzlu, H. B., Kocabas, C. and Dahiya, R., “Synthesis of large area graphene for high performance in flexible optoelectronic devices,” Sci. Rep., vol. 5, p. 16744, 2015.
Popov, V. N., “Carbon nanotubes: properties and application,” Mater. Sci. Eng. Rep., vol. 43, no. 3, pp. 61-102, Jan. 15, 2004.
Qi, Y. & McAlpine, M. C., “Nanotechnology-enabled flexible and biocompatible energy harvesting,” Energ. Environ. Sci., vol. 3, no. 9, pp. 1275-1285, 2010.
Quan, T., Zeng, S. and Huang, Z. L., (2010). Journal of Biomedical Optics. 15, 066005. https://doi.org/10.1117/1.3505017
Rao, C. & Govindaraj, A., “Synthesis of inorganic nanotubes,” Adv. Mater., vol. 21, no. 42, pp. 4208-4233, 2009.
Ren, Z. F., et al., “Growth of a single freestanding multiwall carbon nanotube on each nanonickel dot,” Appl. Phys. Lett., vol. 75, no. 8, pp. 1086-1088, August 1999.
Ren, Z. F., et al., “Synthesis of large arrays of well-aligned carbon nanotubes on glass,” Science, vol. 282, no. 5391, pp. 1105-1107, November 1998.
Resch-Genger, U., Grabolle, M., Cavaliere-Jaricot, S., Nitschke, R. and Nann, T., (2008). Natural Methods. 5(9), 763-775. https://doi.org/10.1038/nmeth.1248
Risken, H., The Fokker-Planck Equation, 2 ed. (Springer, 1989).
Ropp, C., Cummins, Z., Nah, S., Fourkas, J. T., Shapiro, B. and Waks, E., Natural Communications. 4, 1447 (2013). https://doi.org/10.1038/ncomms2477
Ross, F. M., “Controlling nanowire structures through real time growth studies,” Rep. Prog. Phys., vol. 73, no. 11, p. 114501, 2010.
Rogalski, A., Progressive Quantum Electrons. 36, 342-473 (2012). Progress in focal plane array technologies. Progress in Quantum Electronics, Volume 36, Issues 2-3, March-May 2012, pp. 342-473.
Roth, S., Krstic, V., and Rikken, G., “Quantum transport in carbon nanotubes,” Curr. Appl. Phys., vol. 2, no. 2, pp. 155-161, 2002.
Ruijgrok, P. V., Verhart, N. R.., Zijlstra, P., Tchebotareva, A. L. and Orrit, M., Physical Review Letters. 107, 037401 (2011). https://doi.org/10.1103/PhysRevLett.107.037401
Rutherglen, C. & Burke, P., “Nanoelectromagnetics: circuit and electromagnetic properties of carbon nanotubes,” Small, vol. 5, no. 8, pp. 884-906, April 2009.
[S]
Saito, R., Dresselhaus, G. & Dresselhaus, M. S., Physical properties of carbon nanotubes. World Scientific, 1998.
Saito, R., Dresselhaus, G. and Dresselhaus, M. S., Physical properties of carbon nanotubes, London: Imperial College Press, 1998.
Sakurai, M., Asakura, M., & Okino, T. (2008). U.S. Pat. No. 7,388,725. Washington, DC: U.S. Patent and Trademark Office.
Scott, C. D., Arepalli, S., Nikolaev, S. P., and Smalley, R. E., “Growth mechanisms for single-wall carbon nanotubes in a laser-ablation process,” Appl. Phys. A-Mater., vol. 72, no. 5, pp. 573-580, May 2001.
Schirhagl, R., Chang, K., M. Loretz, and Degen, C. L., (2014). Annual Review of Physical Chemistry. 65, 83-105. https://doi.org/10.1146/annurev-physchem-040513-103659.
Schmid, H., et al., “Patterned epitaxial vapor-liquid-solid growth of silicon nanowires on Si (111) using silane,” J. Appl. Phys., vol. 103, no. 2, p. 024304, 2008.
Schmidt, V., Senz, S. and G5sele, U., “Diameter dependence of the growth velocity of silicon nanowires synthesized via the vapor-liquid-solid mechanism,” Phys. Rev. B, vol. 75, no. 4, p. 045335, 2007.
Schmidt, V., Wittemann, J. V., Senz, S. and G5sele, U., “Silicon nanowires: a review on aspects of their growth and their electrical properties,” Adv. Mater., vol. 21, no. 25-26, pp. 2681-2702, 2009.
Schmidt, V., Wittemann, J. V., and G5sele, U., “Growth, thermodynamics, and electrical properties of silicon nanowires,” Chem. Rev., vol. 110, no. 1, pp. 361-388, 2010.
Schneider, J., & Hudson, S. (1993). A finite-difference time-domain method applied to anisotropic material. IEEE transactions on antennas and propagation, 41(7), 994-999.
Schneider, J. B. (2010). Understanding the finite-difference time-domain method. School of electrical engineering and computer science Washington State University, 28.
Schwartz, O., Levitt, J. M, Tenne, R., Itzhakov, S., Deutsch, Z. and Oron, D., Nano Letters 13(12), 5832-5836 (2013). https://doi.org/10.1021/nl402552m.
Schwartz, O. & Oron, D., Physical Review. A 85, 033812 (2012). https://doi.org/10.1103/PhysRevA.85.033812.
Seah, C. M., Chai, S. P. and Mohamed, A. R., “Synthesis of aligned carbon nanotubes,” Carbon, vol. 49, no. 14, pp. 4613-4635, November 2011.
Seidel, R., Duesberg, G. S., Unger, E., Graham, A. P. Liebau, M., and Kreupl, F., “Chemical vapor deposition growth of single-walled carbon nanotubes at 600 degrees C. and a simple growth model,” J. Phys. Chem. B, vol. 108, no. 6, pp. 1888-1893, Feb. 12, 2004.
Seitz, P. & Theuwissen, A J. P., Springer Series in Optical Sciences (Springer, 2011), Vol. 160.
Shakthivel, D., Rathkanthiwar, S., and Raghavan, S., “Si nanowire growth on sapphire: Classical incubation, reverse reaction, and steady state supersaturation,” J. Appl. Phys., vol. 117, no. 16, p. 164302, 2015.
Shakthivel, D., Garcia Nunez, C. and Dahiya, R., “Inorganic semiconducting nanowires for flexible electronics,” United Scholars Publications, USA, 2016.
Shakthivel, D., Liu, F., Nunez, C. G., Taube, W. and Dahiya, R., “Nanomaterials processing for flexible electronics,” in Industrial Electronics (ISIE), 2017 IEEE 26th International Symposium on, 2017, pp. 2102-2106: IEEE.
Shakthivel, D. & Raghavan, S., “Vapor-liquid-solid growth of Si nanowires: A kinetic analysis,” J. Appl. Phys., vol. 112, no. 2, p. 024317, 2012.
Shakthivel, D., Taube, W., Raghavan, S. and Dahiya, R., “VLS growth mechanism of Si-nanowires for flexible electronics,” in IEEE 11th Conference on Ph. D. Research in Microelectronics and Electronics (PRIME), 2015, pp. 349-352.
Shang, N. G., Tan, Y. Y., Stolojan, V., Papakonstantinou, P., and Silva, S. R. P., “High-rate low-temperature growth of vertically aligned carbon nanotubes,” Nanotechnology, vol. 21, no. 50, p. 6, December 2010.
Sharma, S. & Sunkara, M., “Direct synthesis of single-crystalline silicon nanowires using molten gallium and silane plasma,” Nanotechnology, vol. 15, no. 1, p. 130, 2003.
Shchegolikhin, A., Lazareva, O., Melnikov, V., Ozeretski, V., Small, L. Raman-active taggants and their recognition. US Patent No. US2002/0025490 A1.
Shechtman, Y., Sahl, S. J., Backer, A. S. and Moerner, W. E., Physical Review Letters. 113(13), 133902 (2014). https://doi.org/10.1103/PhysRevLett.113.133902.
Sheppard, C. J. R. & Gu, M., Optik 86(3), 104-106 (1990). Google Scholar.
Shulaker, M. M., et al., “Carbon nanotube computing,” Nature, vol. 501, no. 7468, p. 526, 2013.
Silvera-Batista, C. A., Scott, D. C., McLeod, S. M. and Ziegler, K. J., “A mechanistic study of the selective retention of SDS-suspended single-wall carbon nanotubes on agarose gels,” J. Phys. Chem. B, vol. 115, no. 19, pp. 9361-9369, 2011.
Singh, N., et al., (2008). “Si, SiGe nanowire devices by top-down technology and their applications,” IEEE. T. Electron. Dev., vol. 55, no. 11, pp. 3107-3118.
Sinnott, S. B., et al., “Model of carbon nanotube growth through chemical vapor deposition,” Chem. Phys. Lett., vol. 315, no. 1-2, pp. 25-30, December 1999.
Sjoback, R., Nygren, J., Kubista, M. and Spectrochim, M. Acta Part A 51, L7-L21 (1995). https://doi.org/10.1016/0584-8539(95)01421-P.
Sofiane, O., & Ouaskit, S. (2017). FDTD Simulations of Surface Plasmons Using the Effective Permittivity Applied to the Dispersive Media. American Journal of Electromagnetics and Applications, 5(2), 14-19.
Sporea, R., Trainor, M., Young, N., Shannon, J. and Silva, S., “Source-gated transistors for order-of-magnitude performance improvements in thin-film digital circuits,” Sci. Rep., vol. 4, 2014.
Striakhilev, D., Nathan, A., Vygranenko, Y., Servati, P., Lee, C. H. and Sazonov, A., “Amorphous silicon display backplanes on plastic substrates,” J. Disp. Technol., vol. 2, no. 4, pp. 364-371, 2006.
Stein, D. M. (2013). U.S. Pat. No. 8,426,807. Washington, DC: U.S. Patent and Trademark Office.
Su, B., Wu, Y. and Jiang, L., “The art of aligning one-dimensional (1D) nanostructures,” Chem. Soc. Rev., vol. 41, no. 23, pp. 7832-7856, 2012.
Su, J., Sun, C., & Wang, X. Q. (2013). A metallic dispersion model for numerical simulation. Journal of Optoelectronics Laser, 24(2), 408-411.
Su, M., Zheng, B., and Liu, J., “A scalable CVD method for the synthesis of single-walled carbon nanotubes with high catalyst productivity,” Chem. Phys. Lett., vol. 322, no. 5, pp. 321-326, May 2000.
Su, X., Koo, T., and Berlin, A., et al. (2005) Programmable molecular barcodes. US Patent No. US2005/0064435 A1.
Sugimura, A., Daikoku, K., Imoto, N., & Miya, T. (1980). Wavelength dispersion characteristics of single-mode fibers in low-loss region. IEEE Journal of Quantum Electronics, 16(2), 215-225.
Sugunan, A., Warad, H. C., Boman, M. and Dutta, J., “Zinc oxide nanowires in chemical bath on seeded substrates: Role of hexamine,” J. Sol-Gel. Sci. Techn, vol. 39, no. 1, pp. 49-56, Jul. 1, 2006.
Sun, Y. & Rogers, J. A., (2010) Semiconductor nanomaterials for flexible technologies: From photovoltaics and electronics to sensors and energy storage. William Andrew.
Sun, Y. & Rogers, J. A., “Inorganic semiconductors for flexible electronics,” Adv. Mater., vol. 19, no. 15, pp. 1897-1916, 2007.
Sun, Y., Wang, L., Yu, X. and Chen, K., “Facile synthesis of flower-like 3D ZnO superstructures via solution route,” Cryst. Eng. Comm., vol. 14, no. 9, pp. 3199-3204, 2012.
Sunkara, M. K., et al., “Bulk synthesis of silicon nanowires using a low-temperature vapor-liquid-solid method,” Appl. Phys. Lett, vol. 79, no. 10, pp. 1546-1548, 2001.
Takei, K., et al., “Nanowire active-matrix circuitry for low-voltage macroscale artificial skin,” Nat. Mater., vol. 9, no. 10, pp. 821-826, 2010.
Takeshi, T., Hehua, J., Yasumitsu, M., and Hiromichi, K., “High-yield separation of metallic and semiconducting single-wall carbon nanotubes by agarose gel electrophoresis,” Appl. Phys. Express, vol. 1, no. 11, p. 114001, 2008.
Tamburini, F., Anzolin, G., Umbriaco, A. Bianchini, and Barbieri, C. (2006) Overcoming the Rayleigh Criterion Limit with Optical Vortices. Physics Review Letters. 97, 163903-Published 16, October.
Tanaka, T., et al., “Simple and scalable gel-based separation of metallic and semiconducting carbon nanotubes,” Nano Lett., vol. 9, no. 4, pp. 1497-1500, 2009.
Tans, S. J., et al., “Individual single-wall carbon nanotubes as quantum wires,” Nature, vol. 386, no. 6624, pp. 474-477, April 1997.
Teo, K. B. K., et al., “Uniform patterned growth of carbon nanotubes without surface carbon,” Appl. Phys. Lett, vol. 79, no. 10, pp. 1534-1536, September 2001.
Thess, A., et al., “Crystalline ropes of metallic carbon nanotubes,” Science, vol. 273, no. 5274, pp. 483-487, July 1996.
Tessonnier, J. P. & Su, D. S., “Recent progress on the growth mechanism of carbon nanotubes: a review,” Chemsuschem, vol. 4, no. 7, pp. 824-847, 2011.
Thostenson, E. T., Ren, Z. F., and Chou, T. W., “Advances in the science and technology of carbon nanotubes and their composites: a review,” Compos. Sci. Technol., vol. 61, no. 13, pp. 1899-1912, 2001.
Tian, Z. R., Voigt, J. A., Liu, J., McKenzie, B., and McDermott, M. J., “Biomimetic arrays of oriented helical ZnO nanorods and columns,” J. Am. Chem. Soc., vol. 124, no. 44, pp. 12954-12955, 2002.
Tian, J. H., et al., “Improved seedless hydrothermal synthesis of dense and ultralong ZnO nanowires,” Nanotechnology, vol. 22, no. 24, p. 9, May 2011, Art. no. 245601.
Tian, Z. R., et al., “Complex and oriented ZnO nanostructures,” Nat. Mater., vol. 2, p. 821, 2003.
Tu, X., Manohar, S., Jagota, A. and Zheng, M., “DNA sequence motifs for structure-specific recognition and separation of carbon nanotubes,” Nature, vol. 460, p. 250, 2009.
Tyrakowski, C. M. & Snee, P. T., Physical Chemistry 16, 837-855 (2014). https://doi.org/10.1039/C3CP53502A
Ulanowski, Z., Hirst, E., Kaye, P. H., & Greenaway, R. (2012). Retrieving the size of particles with rough and complex surfaces from two-dimensional scattering patterns. Journal of Quantitative Spectroscopy and Radiative Transfer, 113(18), 2457-2464.
van den Broek, B., Ashcroft, B., Oosterkamp, T. H. and van Noort, J., Nano Letters. 13(3), 980-986 (2013). https://doi.org/10.1021/n13040509.
van der Veen, M. H., et al., “Electrical characterization of CNT contacts with Cu Damascene top contact,” Microelectron. Eng., vol. 106, pp. 106-111, June 2013.
Vayssieres, L., Keis, K., Lindquist, S. E. and Hagfeldt, A., “Purpose-built anisotropic metal oxide material: 3D highly oriented microrod array of ZnO,” J. Phys. Chem. B, vol. 105, no. 17, pp. 3350-3352, 2001.
Verges, M. A., Mifsud, A. and Serna, C. J., “Formation of rod-like zinc oxide microcrystals in homogeneous solutions,” J. Chem. Soc. Faraday. T., vol. 86, no. 6, pp. 959-963, 1990.
Villa, F., Bronzi, D., Zou, Y., Scarcella, C., Boso, G., Tisa, T., Tosi, A., Zappa, F., Durini, D.,
Weyers, S. and Paschen, U., (2014). Journal Modern Optics 61(2), 102-115. https://doi.org/10.1080/09500340.2013.864425.
Wacaser, B. A., et al., “Preferential interface nucleation: an expansion of the VLS growth mechanism for nanowires,” Adv. Mater., vol. 21, no. 2, pp. 153-165, 2009.
Wagner, R. S. & Ellis, W. C., “Vapor-liquid-solid mechanism of single crystal growth,” Appl. Phys. Lett, vol. 4, no. 5, pp. 89-90, 1964.
Wagner, R. & Doherty, C., “Controlled vapor-liquid-solid growth of silicon crystals,” J. Electrochemistry Soc., vol. 113, no. 12, pp. 1300-1305, 1966.
Wang, C., et al., “Extremely bendable, high-performance integrated circuits using semiconducting carbon nanotube networks for digital, analog, and radio-frequency applications,” Nano Lett., vol. 12, no. 3, pp. 1527-1533, 2012.
Wang, H., Kong, H., Zheng, J., Peng, H., Cao, C., Qi, Y. and Chen, W. (2020). Systematically exploring molecular aggregation and its impact on surface tension and viscosity in high concentration solutions. Molecules, 25(7), 1588.
Wang, N., Cai, Y. and Zhang, R. Q., “Growth of nanowires,” Mater. Sci. Eng. Rep., vol. 60, no. 1-6, pp. 1-51, Mar. 31, 2008.
Wang, Z. L., “ZnO nanowire and nanobelt platform for nanotechnology,” Mater. Sci. Eng. Rep., vol. 64, no. 3, pp. 33-71, 2009.
Wallentin, J. & Borgström, M. T., “Doping of semiconductor nanowires,” J. Mater. Res., vol. 26, no. 17, pp. 2142-2156, 2011.
Wanit, M., et al., “ZnO nano-tree growth study for high efficiency solar cell,” Energy Procedia, vol. 14, pp. 1093-1098, 2012.
Wei, B. Q., Vajtai, R., and Ajayan, P. M., “Reliability and current carrying capacity of carbon nanotubes,” (in English), Appl. Phys. Lett., vol. 79, no. 8, pp. 1172-1174, August 2001.
Wen, C. Y., et al., “Periodically changing morphology of the growth interface in Si, Ge, and GaP nanowires,” Phys. Rev. Lett., vol. 107, no. 2, p. 025503, 2011.
Wen, J. G., Lao, J. Y., Wang, D. Z., Kyaw, T. M., Foo, Y. L. and Ren, Z. F., “Self-assembly of semiconducting oxide nanowires, nanorods, and nanoribbons,” Chem. Phys. Lett., vol. 372, no. 5, pp. 717-722, 2003.
Wen, Q., et al., “Growing 20 cm long DWNTs/TWNTs at a rapid growth rate of 80-90 um/s,” Chem. Mater., vol. 22, no. 4, pp. 1294-1296, 2010. CrossRefI Google Scholar
Xia, Y., et al., “One-dimensional nanostructures: synthesis, characterization, and applications,” Adv. Mater., vol. 15, no. 5, pp. 353-389, 2003.
Xiang, J., Lu, W, Hu, Y, Wu, Y., Yan, H., and Lieber, C. M., “Ge/Si nanowire heterostructures as high-performance field-effect transistors,” Nature, vol. 441, no. 7092, pp. 489-493, 2006.
Xu, H., Zheng, Z., Zhang, L. Z., Zhang, H. L. and Deng, F., “Hierarchical chlorine-doped rutile TiO2 spherical clusters of nanorods: large-scale synthesis and high photocatalytic activity,” J. Solid State Chem., vol. 181, no. 9, pp. 2516-2522, September 2008.
Xu, S., et al., “Patterned growth of vertically aligned ZnO nanowire arrays on inorganic substrates at low temperature without catalyst,” J. Am. Chem. Soc., vol. 130, no. 45, pp. 14958-14959, 2008.
Xu, S., Lao, C., Weintraub, B. and Wang, Z. L., “Density-controlled growth of aligned ZnO nanowire arrays by seedless chemical approach on smooth surfaces,” J. Mater. Res., vol. 23, no. 8, pp. 2072-2077, August 2008.
Xu, S. and Wang, Z. L., “One-dimensional ZnO nanostructures: solution growth and functional properties,” Nano. Res., vol. 4, no. 11, pp. 1013-1098, Nov. 1, 2011.
Yang, P., “The chemistry and physics of semiconductor nanowires,” MRS Bull., vol. 30, no. 2, pp. 85-91, 2005.
Yang, P., Feng, Q., Hong, G., Kattawar, G. W., Wiscombe, W. J., Mishchenko, M. I., . . . & Sokolik, I. N. (2007). Modeling of the scattering and radiative properties of nonspherical dust-like aerosols. Journal of Aerosol Science, 38(10), 995-1014.
Yang, C., Zhong, Z., and Lieber, C. M., “Encoding electronic properties by synthesis of axial modulation-doped silicon nanowires,” Science, vol. 310, no. 5752, pp. 1304-1307, 2005.
Yerushalmi, R., et al., “Large scale, highly ordered assembly of nanowire parallel arrays by differential roll printing,” Appl. Phys. Lett, vol. 91, no. 20, p. 203104, 2007.
Yildiz, A., Forkey, J. N., McKinney, S. A., Ha, T., Goldman, Y. E. and Selvin, P. R., Science 300, 2061-2065 (2003). https://doi.org/10.1126/science.1084398
Yin, Y., Jiang, B., Zhu, X., Meng, L., & Huang, Y. (2018). Investigation of thermostability of modified graphene oxide/methylsilicone resin nanocomposites. Engineered Science, 5(6), 73-78.
Yokoyama, D., et al., “Low temperature grown carbon nanotube interconnects using inner shells by chemical mechanical polishing,” Appl. Phys. Lett., vol. 91, no. 26, p. 263101, Dec. 24 2007.
Yong, Y. K., Moheimani, S. O. R., Kenton, B. J. and Leang, K. K., (2012). Review of Scientific Instrumentation. 83, 121101-121122. https://doi.org/10.1063/1.4765048, Google Scholar Citation, ISI.
Yuan, D., Ding, L., Chu, H., Feng, Y., McNicholas, T. P. and Liu, J., “Horizontally aligned single-walled carbon nanotube on quartz from a large variety of metal catalysts,” Nano Lett., vol. 8, no. 8, pp. 2576-2579, August 2008.
Yudasaka, M., Zhang, M. and Iijima, S., “Diameter-selective removal of single-wall carbon nanotubes through light-assisted oxidation,” Chem. Phys. Lett., vol. 374, no. 1, pp. 132-136, 2003.
Yudasaka M., et al., “Behavior of Ni in carbon nanotube nucleation,” Appl. Phys. Lett., vol. 70, no. 14, pp. 1817-1818, April 1997.
Yudasaka, M., et al., “Specific conditions for Ni catalyzed carbon nanotube growth by chemical-vapor-deposition,” Appl. Phys. Lett., vol. 67, no. 17, pp. 2477-2479, October 1995.
Zambov, L., “Kinetics of homogeneous decomposition of silane,” J. Cryst. Growth, vol. 125, no. 1, pp. 164-174, 1992.
Zhang, A., Zheng, G. and Lieber, C. M., Nanowires: Building blocks for nanoscience and nanotechnology. Springer, 2016.
Zhang, H., Wu, B., Hu, W. and Liu, Y., “Separation and/or selective enrichment of single-walled carbon nanotubes based on their electronic properties,” Chem. Soc. Rev., vol. 40, no. 3, pp. 1324-1336, 2011.
Zhang, R., Y. Lifshitz, and S. T. Lee, “Oxide-assisted growth of semiconducting nanowires,” Adv. Mater., vol. 15, no. 7-8, pp. 635-640, 2003.
Zhang, T., Dong, W., Keeter-Brewer, M., Konar, S., Njabon, R. N. and Tian, Z. R., “Site-specific nucleation and growth kinetics in hierarchical nanosynthesis of branched ZnO crystallites,” J. Am. Chem. Soc., vol. 128, no. 33, pp. 10960-10968, 2006.
Zhang, Y., Xu, J., Xiang, Q., Li, H., Pan, Q. and Xu, P., “Brush-like hierarchical ZnO nanostructures: synthesis, photoluminescence and gas 98sensor properties,” J. Phys. Chem. B, vol. 113, no. 9, pp. 3430-3435, 2009.
Zhang, Y., et al., “Silicon nanowires prepared by laser ablation at high temperature,” Applied Physics Letters, vol. 72, no. 15, pp. 1835-1837, 1998.
Zhao, H., Zhou, S., Z. Hasanali, Z., Wan, D., “Influence of pressure on silicon nanowire growth kinetics,” J. Phys. Chem. B, vol. 112, no. 15, pp. 5695-5698, 2008.
Zhao, H., et al., “Influence of pressure on silicon nanowire growth kinetics,” Journal of Physical Chemistry. B, vol. 112, no. 15, pp. 5695-5698, 2008.
Zheng, Q., Juette, M. F., Jockusch, S., Wasserman, M. R., Zhou, Z., Altman, R. B. and Blanchard, S. C., (2014). Chemistry Society Review. 43, 1044-1056. https://doi.org/10.1039/C3CS60237K.

1. The micro- to nano-meter scale component parts of the M-TD^{nm} including Si (silicone molecule) substrate, conduction band, and membrane, provide for an ‘E-beam resist’ function.

2. The E-beam resist layer is coded with an arrangement of electrons, serving as a unique identifier.

3. The M-TD^{nm} will be interrogated via Raman spectroscopy (Raman spectrum reading) will be interpreted via an optical frequency identification (OFiD) method.
